(19) United States
(12) Patent Application Publication
(10) Pub. No.: US 2025/0337680 A1
(43) Pub. Date: Oct. 30, 2025

(54) MULTI-ACCESS PATH MANAGEMENT AND DELIVERY FOR MULTIMEDIA STREAMING

(71) Applicant: Samsung Electronics Co., Ltd., Suwon-si (KR)

(72) Inventor: Prakash Reddy Kolan, Plano, TX (US)

(21) Appl. No.: 19/096,512

(22) Filed: Mar. 31, 2025

Related U.S. Application Data
(60) Provisional application No. 63/638,736, filed on Apr. 25, 2024.
(60) Provisional application No. 63/652,381, filed on May 28, 2024.
(60) Provisional application No. 63/698,929, filed on Sep. 25, 2024.

(51) Int. Cl. H04L 45/302

(52) U.S. Cl. CPC H04L 45/302

(57) ABSTRACT

A method performed by a user equipment (UE) in a communication network with multiple access networks includes receiving, from a network entity, an indication of quality of service (QOS) parameters for each path combination available via the multiple access networks. The method also includes determining, based on the QoS parameters, a path combination for data transmission. The method also includes performing scheduling decisions for transmitting data based on the path combination. The method also includes transmitting the data over the path combination.

### CROSS-REFERENCE TO RELATED APPLICATION AND PRIORITY CLAIM

This application claims priority under 35 U.S.C. § 119 (e) to U.S. Provisional Patent Application No. 63/638,736 filed on Apr. 25, 2024, U.S. Provisional Patent Application No. 63/652,381 filed on May 28, 2024, and U.S. Provisional Patent Application No. 63/698,929 filed on Sep. 25, 2024, which are hereby incorporated by reference in their entirety.

### TECHNICAL FIELD

This disclosure relates generally to multimedia delivery networks, devices, and processes. More specifically, this disclosure relates to multi-access path management and delivery for multimedia streaming.

### BACKGROUND

Cellular mobile devices and networks have evolved over a period of time. Today, mobile devices are equipped with multiple access technologies such as Wi-Fi, long-term evolution (LTE), 5G new radio (NR), satellite access, etc. Different services are being delivered to end users accessible through these different access technologies. Traditionally, a service accessed by the end user was available through one of the available access points on the user terminal. There has been an effort to deliver services that are accessible through more than one access network because of integration of multiple access networks with 3rd Generation Partnership (3GPP) cellular networks. Moreover, services are being provisioned that may be accessed simultaneously by more than one access technology on the end user device.

### SUMMARY

This disclosure provides multi-access path management and delivery for multimedia streaming.

In a first embodiment, a method performed by a user equipment (UE) in a communication network with multiple access networks includes receiving, from a network entity, an indication of quality of service (QOS) parameters for each path combination available via the multiple access networks. The method also includes determining, based on the QoS parameters, a path combination for data transmission. The method also includes performing scheduling decisions for transmitting data based on the path combination. The method also includes transmitting the data over the path combination.

In a second embodiment, an apparatus includes a transceiver and a processor. The processor is configured to receive, from a network entity in a communication network with multiple access networks, an indication of quality of service (QOS) parameters for each path combination available via the multiple access networks. The processor is also configured to determine, based on the QoS parameters, a path combination for data transmission. The processor is also configured to perform scheduling decisions for transmitting data based on the path combination. The processor is also configured to transmit the data over the path combination.

In a third embodiment, a network entity apparatus in a communication network with multiple access networks includes a transceiver and a processor. The processor is configured to provide, to a user equipment, an indication of quality of service (QOS) parameters for each path combination available via the multiple access networks. The processor is also configured to receive, based on the QoS parameters, a path combination for data transmission. The processor is also configured to transmit data over the path combination based on one or more scheduling decisions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4 illustrates an example multi-access delivery architecture in accordance with this disclosure;

FIG. 5 illustrates an example architecture for access specific adaptations in accordance with this disclosure;

FIG. 6 illustrates an example architecture for access specific representations in accordance with this disclosure;

FIG. 7 illustrates an example process for per-access quality of server (QoS) for multi-access assistance in accordance with this disclosure;

FIG. 8 illustrates an example process for offloading representations to a new access network in accordance with this disclosure;

FIG. 9 illustrates an example process for multi-access delivery provisioning in accordance with this disclosure;

FIG. 10 illustrates an example process for network-initiated multi-access path management in accordance with this disclosure;

FIG. 11 illustrates an example process for client-initiated multi-access path management in accordance with this disclosure;

FIG. 12 illustrates an example process for switching from a multi-access session to a single access session in accordance with this disclosure;

FIG. 13 illustrates an example process for switching from a single access session to a multi-access session in accordance with this disclosure;

FIG. 14A illustrates an example intra-public land mobile network (PLMN) scenario in accordance with this disclosure;

FIG. 14B illustrates an example inter-PLMN scenario in accordance with this disclosure;

FIG. 15 illustrates an example dual steering architecture in accordance with this disclosure;

FIG. 16 illustrates example steering functionalities in a user equipment model as specified in Access Traffic Steering, Switching, Splitting (ATSSS) architecture;

FIG. 17 illustrates an example multi-access media delivery architecture in accordance with this disclosure;

FIG. 18 illustrates another example multi-access media delivery architecture in accordance with this disclosure;

FIG. 19 illustrates an example stream mapping process in accordance with this disclosure;

FIGS. 20A and 20B illustrate example multi-path delivery indication processes in accordance with this disclosure;

FIGS. 21A and 21B illustrate example multi-path delivery condition information processes in accordance with this disclosure;

FIGS. 22A and 22B illustrate example processes for dynamic policy management with multi-path delivery in accordance with this disclosure;

FIG. 23A illustrates an example single content distribution network (CDN) delivery process in accordance with this disclosure;

FIG. 23B illustrates an example multi-CDN delivery process in accordance with this disclosure;

FIG. 24 illustrates an example process for multi-CDN and multi-access delivery through MNO supported access networks in accordance with this disclosure;

FIG. 25 illustrates an example process for multi-CDN and multi-access delivery through an MNO supported access network and an unmanaged access network in accordance with this disclosure;

FIG. 26 illustrates an example process for multi-CDN and multi-access delivery through an MNO supported access network and an unmanaged access network in accordance with this disclosure;

FIG. 27 illustrates an example process for multi-CDN and multi-access delivery with network slicing in accordance with this disclosure;

FIGS. 28A and 28B illustrate an example method for multi-access delivery for a user equipment apparatus in accordance with this disclosure; and

FIGS. 29A and 29B illustrate an example method using multi-access delivery for a network entity apparatus in accordance with this disclosure.

### DETAILED DESCRIPTION

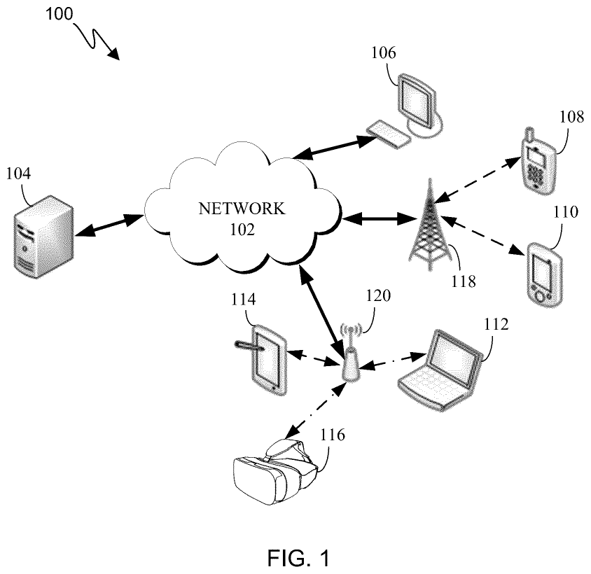

FIGS. 1 through 29B, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, cellular mobile devices and networks have evolved over a period of time. Today, mobile devices are equipped with multiple access technologies such as Wi-Fi, LTE, 5G NR, satellite access, etc. Different services are being delivered to end users accessible through these different access technologies. Traditionally, a service accessed by the end user was available through one of the available access points on the user terminal. There has been an effort to deliver services that are accessible through more than one access network because of integration of multiple access networks with 3rd Generation Partnership (3GPP) cellular networks. Moreover, services are being provisioned that may be accessed simultaneously by more than one access technology on the end user device.

Availability of multiple access technologies on end user devices, and the ability to provide services that may be accessed by one or more access technology simultaneously introduce a lot of issues owning to different quality of service capabilities available on different access technologies. Standard specifications are being developed for use of multi-access technologies, but service layer issues still remain. Multimedia streaming is a technology designed to adapt to changing network conditions, but technologies like these were designed to run on single transport connections. With multiple transport connections now possible between the end user devices and the network for a streaming session, the inherent quality issues of different quality of service (QOS) networks are felt at the service/application layer.

New enablers are being defined with latest 5G networks to utilize the maximum capacity of mobile devices to help with delivering appropriate service experiences to end users. As part of this effort, standard organizations are specifying accessing operator services and application service provider services using multiple access/connectivity technologies (e.g., 5G, 4G-LTE, WIFI, Satellite access etc.) available at the end user devices. Multiple access technologies can be used simultaneously in a session setup to access the operator provider service or application service provider service. By utilizing multiple connectivity technologies, the available throughput can be maximized, and therefore can better cater to the bandwidth and throughput requirements of next generation services.

Multi-access delivery techniques are being devised that help with accessing network services, operator services, and application service provider services using multiple access/connectivity technologies at the end user device simultaneously. With the benefits of increased bandwidth and throughput with multi-access-delivery comes problems related to management of those one or more access network paths (e.g., scheduling access paths to maintain the throughput, switching application flows) as each of the access path connection is associated with its own performance and quality guarantees. Utilizing multiple network paths simultaneously do not always lead to increased throughput/bandwidth, but sometimes can lead to bad path quality and service experience if scheduling is not properly performed between those paths. This disclosure describes methods for path management with multi-access delivery specifically related to media streaming services.

Manufacturers of mobile terminal devices (e.g., smart homes, laptops etc.) have started to support communication services over multiple access technologies. Devices can be equipped with multiple access endpoints such as Wi-Fi endpoints, LTE, 5G NR etc. Next generation services require high throughput and low latency facilities to the endpoint devices from the communication network. In this context, it becomes beneficial that UE terminal devices use all facilities available for receiving these next generation services. One such utilization of user equipment (UE) terminal devices capabilities is the use of multiple access technologies. UE terminal devices may access these next generation services using multiple accesses at the same time, thereby utilizing the individual capabilities of their endpoints for realizing successful delivery of the above next generation services.

Media Streaming technologies have traditionally allowed streaming media content from one or more content distribution networks. With these technologies, media streaming clients are informed about availability of media segments at one or more of these content distribution networks (CDNs), and the media streaming clients download/stream content from application services in these CDN networks. Generally, the streaming clients use a single transport connection over one access network to connect to those application services in different CDN networks. However, with multiple access network connectivity capabilities of individual UE terminal devices, it is possible that streaming clients use one or more of them to download/stream content from different application servers in different CDN networks. This disclosure describes methods for retrieval of media segments from different application services/servers in different CDN networks over one or more access networks thereby allowing multi-CDN and multi-access mechanisms.

The disclosure also describes aspects related to adapting multimedia streaming service layer methods to support multi-access delivery and provisioning of multimedia streaming services by streaming service provider in networks and devices with multi-access capabilities. This disclosure provides for access specific adaptations and representations to support multimedia adaptive bit streaming in multi-access networks and devices, and methods for managing multi-access connection paths to preserve quality of higher layer multimedia application streams.

This disclosure also provides for management of multiple paths over multiple access networks between the UE and the network for a media streaming session and information elements and procedures to manage and optimize delivery of media application flows over multiple access networks. This includes a multi-path delivery notification information format between the UE and the network, and procedures for path management for multi-access delivery using the above information format, as well as method for deciding on appropriate path combination to use when multiple paths over multiple access technologies to reach the application server in the network are available.

This disclosure also describes aspects related to multi-access and multi-CDN delivery over managed and unmanaged operator networks and availability of Application Services over specific access networks. This disclosure provides methods for retrieval of full and partial media segments over specific access networks as well as methods for retrieval of different representations of application streams over specific access networks to support adaptive bit rate mechanisms.

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included a given device is increasing. Even with the increase of processing power portable electronic devices often struggle to provide the processing capabilities to handle new services and applications, as newer services and applications often require more resources that is included in a portable electronic device. Improved methods and apparatus for configuring and deploying media processing in the network is required.

Cloud media processing is gaining traction where media processing workloads are setup in the network (e.g., cloud) to take advantage of advantages of the benefits offered by the cloud such as (theoretically) infinite compute capacity, auto-scaling based on need, and on-demand processing. An end user client can request a network media processing provider for provisioning and configuration of media processing functions as required.

Various embodiments of this disclosure can be used with multimedia streaming using 5GNR and Wi-Fi. For example, streaming service providers may have agreements with network operators to provider streaming services to mobile network operator end users. The agreements may include simultaneous delivery of multimedia streaming content over more than one access network (e.g., using both 5GNR and Wi-Fi). The network operator provides necessary gateway devices (e.g., N3IWF) to integrate a non-3GPP access network such as Wi-Fi. As a result, multimedia streams from streaming service provider may be delivered to end user devices over both 5GNR and Wi-Fi separately. In addition, the network operator may provider traffic steering, switching and splitting of multimedia streaming traffic over all the available access networks.

Various embodiments of this disclosure can be used with broadcast TV services over 5G NR and ATSI endpoints. For example, broadcast TV service providers may provide broadcast TV services to cellular network users. The Broadcast content may be delivered through more than one access network (e.g., both ATSI and 5GNR terminal endpoints). The service provider may provide high fidelity broadcast content over ATSI endpoint, and have separate unicast streams per user over 5G NR access. The network operator may assist the broadcast TV service operator in traffic steering, switching and splitting of TV streaming traffic over all the available access networks.

Various embodiments of this disclosure can be used with a UE using terrestrial and satellite access. Satellite access known as wide coverage can improve service availability in areas with poor terrestrial access network coverage or radio condition (e.g. multipath interference). For a UE in high-speed move requests real-time services, e.g. IMS voice/video meeting, it can benefit from dual connectivity with 5G system through terrestrial access and satellite access simultaneously, and obtain the continuous and reliable service with the minimum impact of terrestrial access network unavailability. For example, a user is traveling to Phoenix for a business trip. He will take high-speed train, which crosses the desert for 450 miles distance at a speed of 300 miles/h, to visit the customer. During the journey, he has to handle urgent work via online video meetings and solve all the issues before arrival. The user's device uses two access networks to reach the intended service.

Various embodiments of this disclosure can be used with multimedia streaming using 5GNR and LTE. Streaming service providers may have agreements with network operators to provide streaming services to mobile network operator end users. The agreements may include simultaneous delivery of multimedia streaming content over more than one access network (e.g., using both 5GNR and LTE). As a result, multimedia streams from streaming service provider may be delivered to end user devices over both 5GNR and LTE. The network operator may provider traffic steering, switching and splitting of multimedia streaming traffic over all the available access networks. In addition, there may be different edge resources available when the UE uses these access networks.

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, an HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can participate in various multimedia multi-access aspects of this disclosure.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and an HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can participate in various multimedia multi-access aspects of this disclosure.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

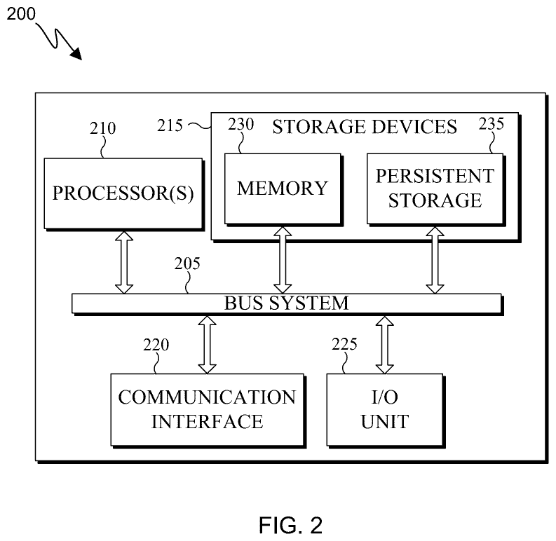

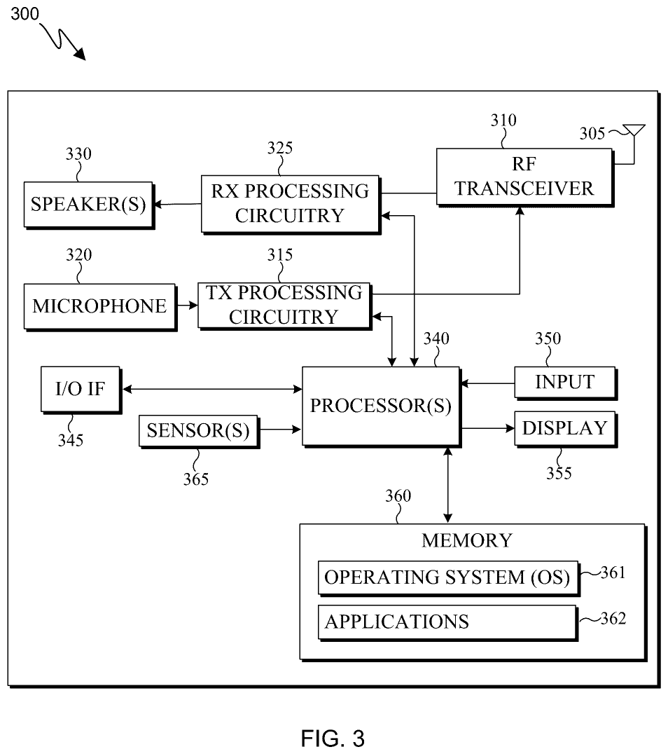

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for supporting multi-access path management and/or other multi-access aspects for delivery of multimedia, as described in embodiments of this disclosure. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. For example, the processor 340 may execute processes for multi-access path management and delivery for multimedia streaming. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

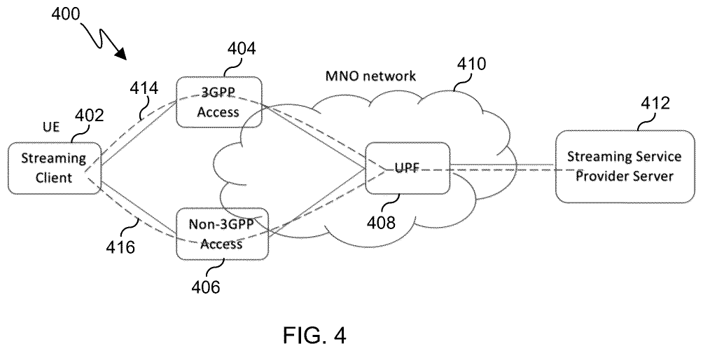

FIG. 4 illustrates an example multi-access delivery architecture 400 in accordance with this disclosure. The multi-access delivery architecture 400 illustrated in FIG. 4 is for illustration only. FIG. 4 does not limit the scope of this disclosure to any particular implementation of a multi-access delivery architecture. For ease of explanation, the architecture 400 of FIG. 4 may be described as being performed using the communication system 100 of FIG. 1. However, the architecture 400 may be used with any other suitable system and using any other suitable electronic device(s).

As shown in FIG. 4, the architecture 400 can include a streaming client 402 (e.g., on a UE) connected to both a cellular access network 404 (e.g., a trusted 3GPP network like 5G NR, LTE, etc. or an untrusted 3GPP access network) and a non-cellular access network 406 (e.g., a trusted non-3GPP access network like an operator managed Wi-Fi network, Worldwide Interoperability for Microwave Access (WiMAX) network, satellite network, etc., or an untrusted non-3GPP access network like an untrusted Wi-Fi network, untrusted WiMAX network, untrusted satellite network, etc.). The architecture 400 also includes protocol data unit (PDU) session anchor point, such as the user plane function (UPF) 408 shown in FIG. 4, provided by a mobile network operator (MNO) network 410, that connects the cellular access network 404 and the non-cellular access network 406 with a streaming service provider server 412. As further shown in FIG. 4, the streaming client can receive a multimedia stream over one or both of a first path 414 associated with the cellular access network 404 and a second path 416 associated with the non-cellular access network 406.

Multi-access is specified in 3GPP TS 23.501 as an optional feature dubbed Access Traffic Steering, Switching, Splitting (ATSSS) in a 5G System. Some aspects of ATSSS includes enabling a multi-Access PDU Connectivity Service, allowing for the exchange of PDUs between the UE, e.g., the streaming client 402, and a data network, e.g., the MNO network 410, by simultaneously using one 3GPP access network, e.g., cellular access network 404, and one non-3GPP access network, e.g., non-cellular access network 407, via two independent N3/N9 tunnels,. e.g., the first and second paths 414, 416, between a PDU session anchor UPF, e.g., the UPF 408, and the radio access network (RAN)/access network (AN).

The multi-access PDU connectivity service can be facilitated by a multi-access PDU (MA PDU) session that may have user plane resources on two access networks. In the context of a media delivery architecture, such as the architecture 400, if conveyed over an MA PDU session the application flow between the media session handler and the media AF at reference point M5 may use two different access networks. If conveyed over an MA PDU Session, the application flow between the media access client and the media AS at reference point M4 may use two different access networks. The UE is supplied with policy rules (“ATSSS rules”) by the network for deciding how to distribute uplink traffic across multiple access networks. Similarly, the UPF anchor is supplied with policy rules (“N4 rules”) by the network for deciding how to distribute downlink traffic across the two N3/N9 tunnels and the two access networks. The network entity configuring ATSSS rules and N4 rules is the SMF. The SMF may map PCC rules from the PCF to create these ATSSS and N4 rules.

The UE indicates its support for ATSSS (steering functionalities and steering modes) in the PDU Session Establishment Request that is sent to request a new MA PDU Session. If the UE requests an S-NSSAI, the same S-NSSAI is allowed on both the access networks.

For QoS support, the same 5G QoS model used for conventional PDU Sessions also applies to MA PDU Sessions, i.e. QoS Flow is the finest granularity of QOS differentiation. However, QoS Flow is access-agnostic: the same network QoS applies to each of the different access network comprising the MA PDU Session, i.e. the same QoS is available across two different paths in different access networks. The network (SMF) may provide QoS rules to the UE via one access network that are used for both the 3GPP access network and non-3GPP access network. In the context of the generalized media delivery architecture, application flows at reference point M5 and/or M4 using a MA PDU Session may have similar network QoS as when they are transmitted via the 3GPP access network alone.

The network may provide Measurement Assistance Information to the UE and/or UPF to assist them in determining which measurements (round trip measurements, packet loss rate measurements) are to be performed before deciding how to distribute traffic across two access networks.

The ATSSS rules provided to the UE by the network contain information about the type of steering functionality to be used to distribute traffic across multiple access networks. Steering functionality is the functionality that can steer, switch, and split traffic across multiple access networks. From clause 5.32.8 of TS 23.501, supported steering functionalities can include higher-layer MPTCP (Multipath TCP) functionality in which the UPF provides MPTCP proxy functionality. Corresponding MPTCP functionality in the UE may communicate with the MPTCP proxy in the UPF to distribute and aggregate traffic across multiple access networks. Supported steering functionalities can also include higher-layer MPQUIC (Multipath-enabled QUIC) functionality in which the UPF provides MPQUIC proxy functionality. The corresponding MPQUIC functionality in the UE may communicate with the MPQUIC proxy in the UPF to distribute and aggregate traffic across multiple access networks. Supported steering functionalities can also include ATSSS-LL (ATSSS Low-Layer) functionality, which is functionality that allows steering, switching, and splitting of traffic across two access networks based on information from IP layer and below.

The ATSSS rules provided to the UE by the network indicates which steering mode is to be applied to matching traffic for each Service Data Flow (SDF). Steering mode determines how the matching traffic is to be distributed across 3GPP and non-3GPP access networks. Supported steering modes in Release 18 include an “active-standby” mode which is used to steer matching SDF packets onto one access network (the “active access”) when this is available, and onto another (the “standby access”) when the Active access is unavailable. Supported steering modes in Release 18 also include a “smallest delay” mode in which matching SDF packets are steered to the access network with smallest packet round-trip time. Supported steering modes in Release 18 also include a “load-balancing” mode which is used to split the delivery of SDF packets between both the access networks if both of them are available. Supported steering modes in Release 18 also include a “priority-based” mode which is used to steer SDF packets onto an access network with a higher priority. Supported steering modes in Release 18 also include a “redundant” mode which is used to duplicate SDF packets on both access networks if both access networks are available.

Although FIG. 4 illustrates one example multi-access delivery architecture 400, various changes may be made to FIG. 4. For example, the number and placement of various components of the multi-access delivery architecture 400 can vary as needed or desired. In addition, the multi-access delivery architecture 400 may be used in any other suitable process or other architectures, such as other architectures of this disclosure, and is not limited to the specific processes or architectures described above.

Various streaming media protocols have been developed. As one example, ISO/IEC 23009-1 is an international standard for dynamic adaptive streaming over HTTP (DASH standard). This specification describes aspects related to transfer of multimedia content over HTTP protocol, thereby enabling HTTP based streaming. Network devices and end user terminals are capable of processing HTTP traffic, so multimedia streaming using HTTP becomes possible. With DASH standard, video streaming servers send a media presentation document (MPD) to streaming clients over HTTP. The streaming clients parse the MPD to get description of different assets involved in the stream (e.g., audio components, video components, subtitle components, metadata etc.) along with when to play what. The streaming clients pass this information to the streaming players on UE devices so the devices know when to play what. To support devices of different natures, media streaming protocols can support using adaptations and representations.

In various streaming protocols, adaptation sets can be used. For instance, according to the ISO/IEC 23009-1 standard, adaptation sets represent a set of interchangeable encoded versions of one or several media content components. For example, there may be an adaptation set for a video component and a separate adaptation set for an audio component of a multimedia stream.

In various streaming protocols, each adaptation set can also have one or more representations for each of the media content components. A representation describes a deliverable encoded version of one or several media content components. Representations allow a client to switch from one version to another depending on the streaming experience quality.

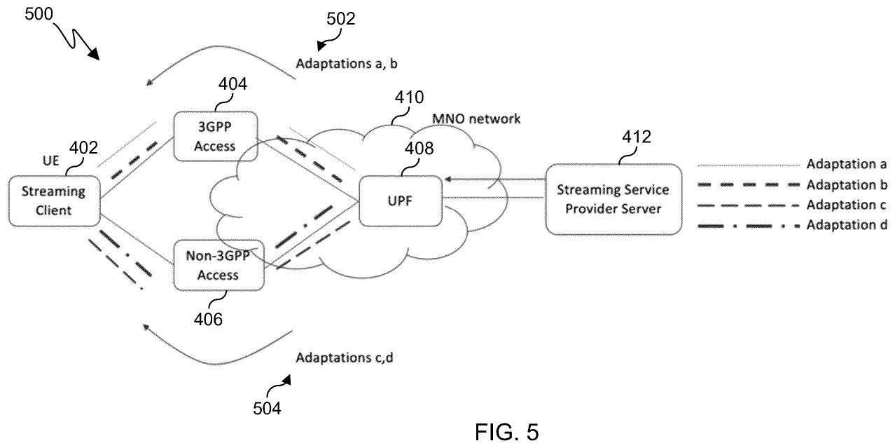

This disclose provides for various embodiments that enable media streaming over multiple access networks. For example, FIG. 5 illustrates an example architecture 500 for access specific adaptations in accordance with this disclosure. The architecture 500 illustrated in FIG. 5 is for illustration only. FIG. 5 does not limit the scope of this disclosure to any particular implementation of an architecture for access specific adaptations. For ease of explanation, the architecture 500 of FIG. 5 may be described as being performed using the communication system 100 of FIG. 1. However, the architecture 500 may be used with any other suitable system and using any other suitable electronic device(s).

As shown in FIG. 5, the architecture 500 includes the streaming client 402, the cellular access network 404, the non-cellular access network 406, the UPF 408, the MNO network 410, and the streaming service provider server 412, such as described with respect to FIG. 4. As shown in FIG. 5, in the example architecture 500, different adaptation sets for a multimedia content can be transmitted over different access paths, such as the access path 414 and the access path 416 shown in FIG. 4. For example, as shown in the example of FIG. 5, a multimedia content may have four adaptations, shown as adaptation a, b, c, and d. Each adaptation may be sent over one of the multiple access paths. For example, as shown in FIG. 5, a first set of adaptations 502, including adaptations a and b in this example, are sent over the path associated with the cellular access network 404, and a second set of adaptations 504, including adaptations c and d in this example, are sent over the path associated with the non-cellular access network 406.

To facilitate transmission of different adaptations over different access paths, there can be access information for each adaptation in the adaptation set. For example, an AdaptationSet element inside MPD information may include the additional information shown in Table 1.

TABLE 1

| Element of Attribute Name | Description |
|---|---|
| @access_id | Identifier of the access network that |
| | may be used for streaming the content |
| @access_network_type | Type of access network. Different types |
| | of access networks are possible: |
| | Trusted 3GPP_Access: Operator trusted |
| | 3GPP access (e.g., NR, LTE etc.) |
| | Untrusted 3GPP_Access: Operator untrusted |
| | 3GPP access |
| | Trusted Non_3GPP_Access: Operator |
| | trusted Non 3GPP access (e.g., operator |
| | managed Wi-Fi, WiMAX, Satellite etc.) |
| | Untrusted Non_3GPP_Access: Operator |
| | untrusted non 3GPP access (e.g., untrusted |
| | Wi-Fi, untrusted WiMAX, untrusted Satellite |
| | etc.) |

In various embodiments, the AdaptationSet can carry the following information separately for each of the multiple accesses the operator may use for streaming content to the end user devices:
Content Type: Type of media component through this access network
Min bandwidth: Minimum bandwidth among all the Representations in the Adaptation set
Max bandwidth: Minimum bandwidth among all the Representations in the Adaptation set
Min width: Minimum width in all Representations in the Adaptation set
Max width: Maximum width in all Representations in the Adaptation set
Min Height: Minimum height in all Representations in the Adaptation set
Max Height: Maximum height in all Representations in the Adaptation set
Min Framerate: Minimum frame rate in all Representations in the Adaptation set
Max Framerate: Maximum frame rate in all Representations in the Adaptation set

All the applicable elements of the AdaptationSet element can be included per each access network. The MPD element may include the above parameters based on different types of access networks discussed in Table 1.

In addition to each AdaptationSet specifying parameters separately for each access, in some embodiments, the higher level MPD element may have a list of applicable adaptation sets for each access network. For this, a period element inside the MPD type element may have the “@access_id” and “@access_network_type” elements shown in Table 1, and for each access_id, the period element may describe an array of applicable adaptation sets specified lower in the MPD. For example, for each period, and for each access network Id/type, the media description document can include parameters separately. With this option, the streaming service provide server 412 may specify a list of adaptations that are common for one or more access networks.

Although FIG. 5 illustrates one example architecture 500 for access specific adaptations, various changes may be made to FIG. 5. For example, the number and placement of various components of the architecture 500 can vary as needed or desired. It will also be understood that, although FIG. 5 illustrates adaptations a and b being sent over the first path and adaptations c and d being sent over the second path, different combinations of adaptations may be sent over the different network paths, such as adaptations b and c instead being sent over the first path, sending three adaptations over one of the paths (or all four), etc. In addition, the architecture 500 may be used in any other suitable process or other architectures, such as other architectures of this disclosure, and is not limited to the specific processes or architectures described above.

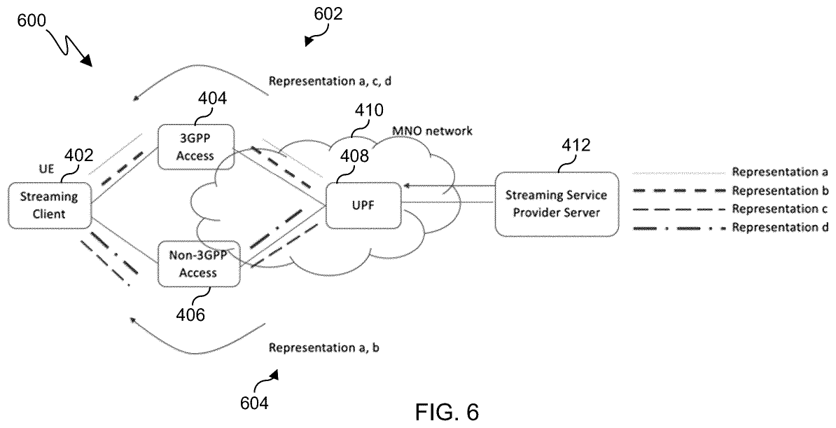

As another example, FIG. 6 illustrates an example architecture 600 for access specific representations in accordance with this disclosure. The architecture 600 illustrated in FIG. 6 is for illustration only. FIG. 6 does not limit the scope of this disclosure to any particular implementation of an architecture for access specific adaptations. For ease of explanation, the architecture 600 of FIG. 6 may be described as being performed using the communication system 100 of FIG. 1. However, the architecture 600 may be used with any other suitable system and using any other suitable electronic device(s).

As shown in FIG. 6, the architecture 600 includes the streaming client 402, the cellular access network 404, the non-cellular access network 406, the UPF 408, the MNO network 410, and the streaming service provider server 412, such as described with respect to FIG. 4. As shown in FIG. 6, in the example architecture 600, different representations for multimedia content can be transmitted over different access paths, such as the access path 414 and the access path 416 shown in FIG. 4. For example, as shown in the example of FIG. 6, a multimedia content may have four representations, shown as representations a, b, c, and d. Each representation may be sent over one of the multiple access paths. For example, as shown in FIG. 6, a first set of representations 602, including representations a, c, and d in this example, are sent over the path associated with the cellular access network 404, and a second set of representations 604, including representations a and b in this example, are sent over the path associated with the non-cellular access network 406.

To facilitate transmission of different representations over different access paths, there can be access information for each representation. For example, in various embodiments, the streaming server 412 may include parameters for a representation separately for each access network. For instance, the representation element inside the AdaptationSet element in the MPD information may include the additional information shown in Table 2.

TABLE 2

| Element of Attribute Name | Description |
|---|---|
| @access_id | Semantics of this element is same as |
| | described earlier in the embodiment |
| @access_network_type | Semantics of this element is same as |
| | described earlier in the embodiment. |

All the applicable elements of the RepresentationType element in can be included per each access network.

In various embodiments, the access information can be applicable for multiple representations. For example, in addition to each RepresentationType specifying parameters separately for each access, in some embodiments, the higher level MPD element for RepresentationType, may have a list of applicable representations for each access network. For this, the AdaptationSet element inside the MPD type element may have the @access_id and @access_network_type elements shown in Table 2, and, for each access_id, the AdaptationSet element may describe an array of applicable representations specified lower in the MPD. For example, within an AdaptationSet, for each access network Id/access network type, the media description document can include parameters separately. With this option, the streaming server 412 may specify list of representations that are common for one or more access networks.

Although FIG. 6 illustrates one example architecture 600 for access specific representations, various changes may be made to FIG. 6. For example, the number and placement of various components of the architecture 600 can vary as needed or desired. It will also be understood that, although FIG. 6 illustrates representations a, c, and d being sent over the first path and representations a and b being sent over the second path, different combinations of adaptations may be sent over the different network paths, such as representations b and c instead being sent over the first path, sending a different number of representations over a one path (or all four over one path), etc. In addition, the architecture 600 may be used in any other suitable process or other architectures, such as other architectures of this disclosure, and is not limited to the specific processes or architectures described above.

As described herein with respect to FIGS. 5 and 6, it will also be understood that a combination of FIGS. 5 and 6 could be used, such that specific representations and specific adaptations can be provided over specific access networks. To facilitate this, for instance, a BaseURL property of the RepresentationType element may point to a URL that is reachable only through specific access network(s). For example, for specific representations, using a trusted NR (5G Radio) access network, e.g., the cellular access network 404, will allow reaching an edge application server providing the required media content component matching that representation.

In some embodiments, the streaming service provider may make available an edge application server that can provide one or more representations only if used through specific access networks, i.e., the edge application servers are only reachable if used through specific access networks.

In some embodiments, in addition to the representations, the streaming service provider may make available some additional adaptations if using one or more specific access networks. This allows a way for the streaming service provider 412 to incentivize access network providers. For example, the streaming service provider may make available additional adaptations if using a 5G NR access network (e.g., access network 404) compared to a non-trusted non-3GPP access (e.g., access network 406) network.

In various embodiments, separate access networks can be used at different time periods. For example, as described in the disclosure, various embodiments of the disclosure include the option of specifying applicable adaptation sets and representations for each access network. By including different access network information for each time period separately, the streaming server 412 may have the option of instructing the streaming client to use different adaptation sets and/or representations at different time periods over different access networks. Further, the streaming server may provide priority information for each access network so the streaming client may look for using that access network during that specific time period. For example, information such as the following may be conveyed to the streaming client. Lower priority numbers signify relatively higher priority compared to higher priority numbers.

This can be represented as follows:

```
<Time period 1 start>
  <Access network 1 priority=5>
    <Adaptation a >
      <Representation X>
      <Representation Y>
    <Adaptation b >
      <Representation X>
      <Representation Z>
  <Access network 2 priority=1>
    <Adaptation a >
      <Representation X>
      <Representation Y>
    <Adaptation c >
      <Representation Z>
      <Representation Y>
<Time period 1 end>
<Time period 2 start>
  <Access network 1 priority=2>
    <Adaptation a >
      <Representation X>
      <Representation Y>
    <Adaptation c >
      <Representation X>
  <Access network 2 priority=4>
    <Adaptation b >
      <Representation Z>
      <Representation Y>
    <Adaptation c >
      <Representation X>
<Time period 2 end>
```

With the above indication to the streaming client, the streaming server may prefer the streaming client use specific access networks at different times with different adaptions and/or representations. However, in various embodiments, since some streaming protocols like DASH are client based, where the client has complete control of requesting appropriate adaptations, the above information can be considered guidance to the client, and therefore it may not be mandatory that the clients strictly follow the recommended access networks. However, if the streaming service provider has not indicated the availability of certain adaptations or representations over certain access networks, it may be possible that the streaming client may not receive traffic of media content components if it ignores the recommendations of the streaming service provider.

Various embodiments of this disclosure can also allow for limiting adaptations and representations for one or more access networks. For example, this disclosure describes representing adaptations and representations available for each access network separately at different time periods. In some embodiments, it is possible that instead of signaling available adaptations and representations for each access network, the streaming server signals the restriction/limitation of accessing one or more adaptions and/or representations over one or more account networks at different time periods.

In such embodiments, the period element in the higher level MPD, such as that described in ISO/IEC 23009-1, may include the identifiers of the unavailable adaptions and/or representations on certain access networks using “Unavailable Adaptions” and “Unavailable Representations” elements, which can be represented as follows:

```
<Time period 1 start>
  <Access network 1>
      <Unavailable adaptation Ids: a, b >
    <Unavailable Representation Ids: X,Y >
  <Access network 2>
      <Unavailable adaptation Ids: c >
    <Unavailable Representation Ids: Y >
<Time period 1 end>
<Time period 2 start>
  <Access network 1>
      <Unavailable adaptation Ids: b >
    <Unavailable Representation Ids: X,Y >
  <Access network 2>
      <Unavailable adaptation Ids: b >
    <Unavailable Representation Ids: X >
<Time period 2 end>
```

When such information is signaled to the streaming client, the client may refrain from requesting given adaptions/representations during the given time periods.

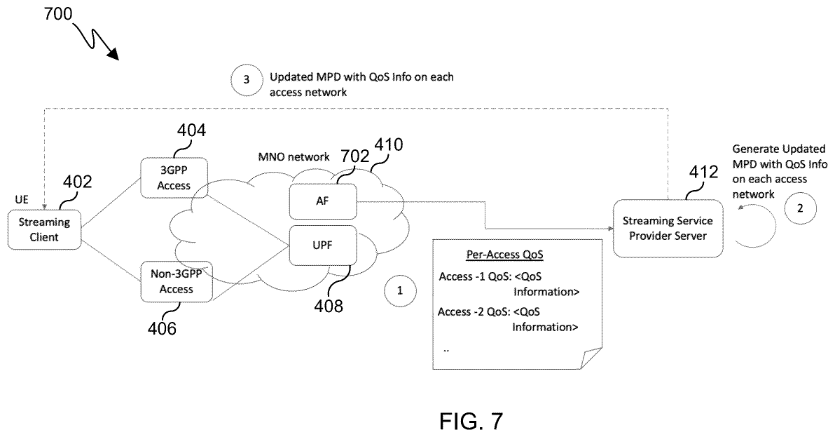

FIG. 7 illustrates an example process 700 for per-access QoS for multi-access assistance in accordance with this disclosure. The process 700 illustrated in FIG. 7 is for illustration only. FIG. 7 does not limit the scope of this disclosure to any particular implementation of a process for per-access QoS for multi-access assistance. For ease of explanation, the process 700 of FIG. 7 may be described as being performed using the communication system 100 of FIG. 1. However, the process 700 may be used with any other suitable system and using any other suitable electronic device(s).

As shown in FIG. 7, the process 700 includes using the streaming client 402, the cellular access network 404, the non-cellular access network 406, the UPF 408, the MNO network 410, and the streaming service provider server 412, such as described with respect to FIG. 4. As also shown in FIG. 7, the MNO network 410 can also include an application function (AF) 702.

As shown in FIG. 7, the streaming service provider server 412, via the AF 702, may provide to the streaming client 402 the QoS information of one or more access networks through which the streaming service provider server 412 may be reached. The streaming service provider may include this information in the media description document, such as the media description document specified in ISO/IEC 23009-1.

Specifically, as shown in FIG. 7, at a first step of the process 700, per-access QoS information for multiple access networks, e.g., access networks 404, 406, is provided to the streaming service provider server 412. At a second step, the streaming service provider server 412 generates an updated MPD with QoS information on each access network. At a third step, the streaming service provider server 412 sends to the streaming client 402 the updated MPD with QoS information on each access network. The streaming client 402 can use the updated MPD to stream content from the streaming service providers server 412 over the different access networks 404, 406.

The following information in Table 3 may be included in the MPD that is sent to the UE.

TABLE 3

| Information Element or | |
|---|---|
| Attribute | Description |
| @per_access_QoS_document | URL to a document with detailed information of per access |
| | QoS that the UE may use for multi-access purposes. The |
| | information in this document provides all the information in |
| | this table. |
| | The streaming service provider may only provide the document |
| | URL without the QoS information described in this table. In |
| | this case, the streaming client may use a separate HTTP |
| | transaction to fetch the QoS document and infer the per-access |
| | QoS values described in this table. |
| @access_cur- | List of access networks' current QoS details. Each entry in the |
| rent_QoS_descriptors | list is a <key, value> pair where the key represents the |
| | @access_id i.e. the identifier of the access network. The value |
| | is a composite object with the following QoS information for |
| | the access network: |
| | Min/max/avg bitrate: Current min/max/average bit rate |
| | for content flowing through the access network |
| | Min/max/avg bandwidth: Current min/max/average |
| | available bandwidth over the access network |
| | Min/max/avg latency: Current min/max/average latency |
| | for content flowing through the access network |
| | Min/max/avg throughput: Current min/max/average |
| | throughput for content flowing through the access |
| | network |
| @access_ex- | List of access networks' expected QoS details based on past |
| pected_QoS_descriptors | history. Each entry in the list is a <key, value> pair where the |
| | key represents the @access_id i.e. the identifier of the access |
| | network. The value is a composite object with the following |
| | QoS information for the access network: |
| | Min/max/avg bitrate: Expected min/max/average bit |
| | rate for content flowing through the access network |
| | Min/max/avg bandwidth: Expected min/max/average |
| | available bandwidth over the access network |
| | Min/max/avg latency: Expected min/max/average |
| | latency for content flowing through the access network |
| | Min/max/avg throughput: Expected min/max/average |
| | throughput for content flowing through the access |
| | network |
| @access_ex- | Time interval for which the above expected QoS values are |
| pected_QoS_time_interval | applicable |

When the streaming client 402 receives the media description document, either the URL to the per-access QoS document, or the detailed statistics in the MPD, the streaming client 402 infers how different access networks are currently performing in terms of QoS parameters and how they are expected to perform based on past history.

In some embodiments, based on the information updated MPD and QoS information, the streaming client 402 may request a network entity in the operator network (e.g., AF 702 in the 5G network) to switch the session to a multi-access PDU session instead of the currently ongoing single access PDU session. In this case, the UE may indicate its support for multi-access delivery, and signal the list of access networks it is willing to include in the multi-access session. When the network entity receives this request, it facilitates setup of multi-access session as described in specification 3GPP TS 23.501.

In some embodiments, based on the information updated MPD and QoS information, the streaming client 402, if the UE is already using a multi-access session, but is not using one of the access networks for which it finds improved QoS performance than the access networks it is currently using, the UE may request the network entity to add this access network in the multi-access session going forward. When the network entity receives such a request from the UE, the network entity facilitates setting up a suitable steering functionality such as MPTCTP or MP-QUIC proxy in the upstream UPF and have the UE facilitate setting up UE side resources for multi-access session including the new access network; or

In some embodiments, based on the information updated MPD and QoS information, the streaming client 402 may, if the UE finds that one of the access networks is under-performing, it may request the network entity to drop that specific access network from the multi-access session.

In some embodiments, based on the information updated MPD and QoS information, the streaming client 402 may, based on the information about QoS on each access network, the streaming client may change the way it requests certain Adaptations and/or Representations over certain access networks.

In various embodiments of this disclosure, the streaming service provider may request the network to provide per-access QoS and QoE information to the provider so it can populate the media description documents appropriately. Such information from the network to the streaming service provider may be performed in various ways. As one example, the streaming service provider may access a REST endpoint nominated by the network entity with a specific API name (e.g., get_per_access_qos_qoe). When the network entity gets such a HTTP GET request, it will send detailed per-access QoS and QoE reports to the streaming service provider. As another example, the streaming service provider, during service and session provisioning methods described in this disclosure, define a QoS_persist_URL to which the network entity can HTTP POST the QoS and QoE reports to.

The format of the QoS and QoE reports from the network entity to the streaming service provider are described earlier in the disclosure. Such reports include the current and expected QoS and QoE details of each of the access network as described earlier in the disclosure on Per Access QoS for multi-access assistance. The network entity may interact with other network entities (e.g., PCF, NWDAF) to get such QoS and QoE metrics of different access networks to pass them to the streaming service provider.

Although FIG. 7 illustrates one example process 700 for per-access QoS for multi-access assistance, various changes may be made to FIG. 7. For example, the number and placement of various components of the process 700 can vary as needed or desired. In addition, the process 700 may be used in any other suitable process or other architectures, such as other architectures of this disclosure, and is not limited to the specific processes or architectures described above.

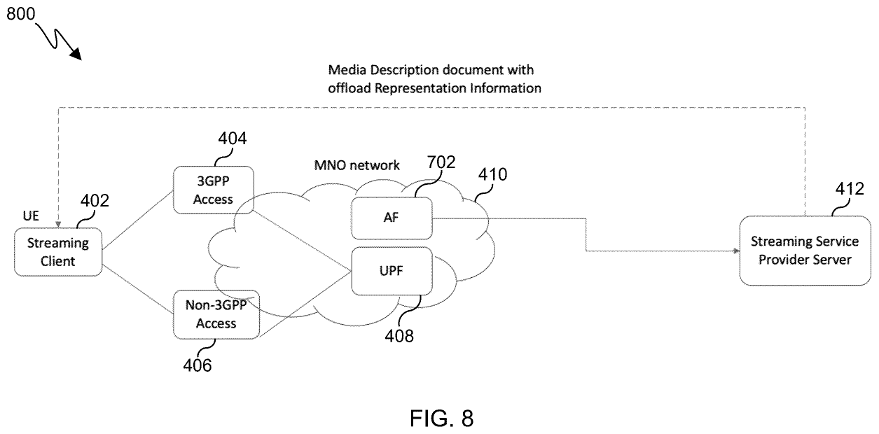

FIG. 8 illustrates an example process 800 for offloading representations to a new access network in accordance with this disclosure. The process 800 illustrated in FIG. 8 is for illustration only. FIG. 8 does not limit the scope of this disclosure to any particular implementation of a process for offloading representations to a new access network. For ease of explanation, the process 800 of FIG. 8 may be described as being performed using the communication system 100 of FIG. 1. However, the process 800 may be used with any other suitable system and using any other suitable electronic device(s).

As shown in FIG. 8, the process 800 includes using the streaming client 402, the cellular access network 404, the non-cellular access network 406, the UPF 408, the MNO network 410, and the streaming service provider server 412, such as described with respect to FIG. 4. As also shown in FIG. 8, the MNO network 410 can also include the AF 702.

As shown in FIG. 8, the process 800 can include the streaming service provider server 412, via the AF 702, providing to the streaming client 402 a media description document, e.g., an MPD, with offload representation information. The streaming client 402 can use the MPD and the offload representation information

As described in this disclosure, multi-access delivery method using ATSSS can use multiple access networks through which the UE can communicate with a UPF data entity in an operator network. Different steering functionalities such as MPTCP, MP-QUIC, and ATSSS-LL have been specified. It is possible that the streaming service provider may want the user to use a different access network when requesting content related to a specific representation during the media presentation, e.g., the streaming service provider may want to offload delivery of content of one or more specific representations to an alternate access network midway through the session.

In some embodiments, to facilitate the offloading, the streaming service provider server 412 may send the updated media description document (e.g., MPD) to the streaming client 402 with new information about an access network to switch to for continuing to receive the content related to one or more representations. The representation information inside the updated MPD may contain the access network information of the new access the streaming service provider wants the streaming client 402 to switch to.

In some embodiments, to facilitate the offloading, the streaming service provider server 412, in the initial MPD may provide additional information in the MPD document such as the following information in Table 4.

TABLE 4

| Element of Attribute Name | Description |
|---|---|
| @offload_representation | Id of the Representation to be |
| | offloaded to a new access network |
| @access_network_id | Id of the access network to which |
| | the above Representation is offloaded to |

In some embodiments, to facilitate the offloading, the streaming service provider server 412, in the initial media description document, may provide a pointer to a document with offload information. Such information may have the following information shown in Table 5.

TABLE 5

| Element of | |
|---|---|
| Attribute Name | Description |
| @offload_de- | URL to an offload description document. The |
| scription_document | document may have the following information: |
| | Action: Action to perform (e.g., offload |
| | Representation) |
| | Access_Network_Id: Id of the access network |
| | to which the above Representation is to be |
| | offloaded to. I.e. the streaming client is to |
| | request the Representation over the suggested |
| | access network. If the streaming client is not |
| | currently using that access, this signals that |
| | streaming client to establish multi-access |
| | delivery with this additional access. The |
| | procedure to request addition of an access to |
| | current delivery mechanism is described in |
| | this disclosure. |
| | Offload_time: Time when the streaming client |
| | is to start having the Representation using the |
| | new access. |
| | Offload_condition: Condition when to offload |
| | Representation to alternate access network. |
| | The condition may be in form of threshold |
| | values to measurements performed at the |
| | streaming client (for example, for parameters |
| | described earlier in disclosure). When the |
| | current values of these parameters fall below |
| | the given threshold values, the condition to |
| | offload Representation to alternate access |
| | evaluates to True. |

Although FIG. 8 illustrates one example process 800 for offloading representations to a new access network, various changes may be made to FIG. 8. For example, the number and placement of various components of the process 800 can vary as needed or desired. In addition, the process 800 may be used in any other suitable process or other architectures, such as other architectures of this disclosure, and is not limited to the specific processes or architectures described above.

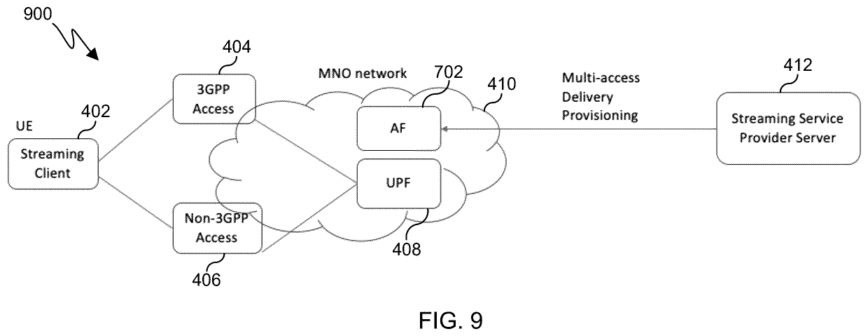

FIG. 9 illustrates an example process 900 for multi-access delivery provisioning in accordance with this disclosure. The process 900 illustrated in FIG. 9 is for illustration only. FIG. 9 does not limit the scope of this disclosure to any particular implementation of a process for multi-access delivery provisioning. For ease of explanation, the process 900 of FIG. 9 may be described as being performed using the communication system 100 of FIG. 1. However, the process 900 may be used with any other suitable system and using any other suitable electronic device(s).

As shown in FIG. 9, the process 900 includes using the streaming client 402, the cellular access network 404, the non-cellular access network 406, the UPF 408, the MNO network 410, and the streaming service provider server 412, such as described with respect to FIG. 4. As also shown in FIG. 9, the MNO network 410 can also include the AF 702.

As shown in FIG. 9, the process 900 includes providing, by the streaming service provider server 412, multi-access delivery provisioning via the AF 702. In particular, the process 900 involves aspects related to provisioning of information into the operator network entity (e.g., 5GMS AF (AF 702), such as that specified in 3GPP TS 26.501) by streaming service provider server 412 (e.g., a 5GMS application provider in 3GPP TS 26.501) to support multi-access delivery.

The multi-access provisioning can involve the following shown in Table 6.

TABLE 6

| Information element or | |
|---|---|
| Parameter | Description |
| Enable-multi-access-delivery | Request to enable multi-access delivery for the streaming |
| | session. If set to True, multi-access mechanisms specified in |
| | 3GPP TS 23501 and this disclosure may be individually |
| | provisioned. If set to False, network provisions a traditional |
| | single-access PDU session between the UE and the network |
| Preferred-steering-functionality | Provision the requested steering functionality among the |
| | supported steering functionalities. Possible values are as |
| | specified in 3GPP TS 23501 and are as follows: |
| | MPTCP |
| | MP-QUIC |
| | ATSSS-LL |
| | When one of the above option is requested by the streaming |
| | service provider for the streaming session, the network |
| | entity provisions an UPF with a respective proxy |
| | functionality and informs the UE of preferred-steering |
| | functionality to the UE. The UE also sets up required proxy |
| | client functionality for supporting the requested steering |
| | functionality |
| Preferred-steering-mode | Provision the requested steering mode. Possible values are |
| | as specified in 3GPP TS 23501 and are as follows: |
| | Active-Standby |
| | Smaller-Delay |
| | Load-Balancing |
| | Priority-based |
| | Redundant |
| | When one of the above option is provisioned, the network |
| | entity configures the steering mode in the UPF using |
| | methodologies specified in 3GPP TS 23501 |
| Access-networks | List of access networks to use in the multi-access session for |
| | the current streaming session. When the network entity |
| | receives this information, it communicates with core and |
| | radio network entities to trigger instantiation of access |
| | networks and provide user plane paths through them so the |
| | UE and streaming service provider server may be able to |
| | communicate with each other. |
| | Each entry in this list is a <key, value> pair where the key |
| | represents the access Id, and the value is a composite object |
| | with the following information: |
| | Access_network_type: Type of access network as |
| | described earlier in the disclosure |
| | QoS_persist_URL: URL where the network entity is |
| | to send detailed QoS and QoE reports of the access |
| | to as described in this disclosure |
| | Note: The streaming service provider may provision a single |
| | REST endpoint to receive reports of all access networks, or |
| | a separate REST endpoint for each of the access networks. |
| Allow-move-to-single-access | Boolean variable to indicate whether the network and/or the |
| | UE may initiate the procedure to move from multi-access |
| | media streaming session to a single-access media streaming |
| | session as described in this disclosure. |

Although FIG. 9 illustrates one example process 900 for multi-access delivery provisioning, various changes may be made to FIG. 9. For example, the number and placement of various components of the process 900 can vary as needed or desired. In addition, the process 900 may be used in any other suitable process or other architectures, such as other architectures of this disclosure, and is not limited to the specific processes or architectures described above.

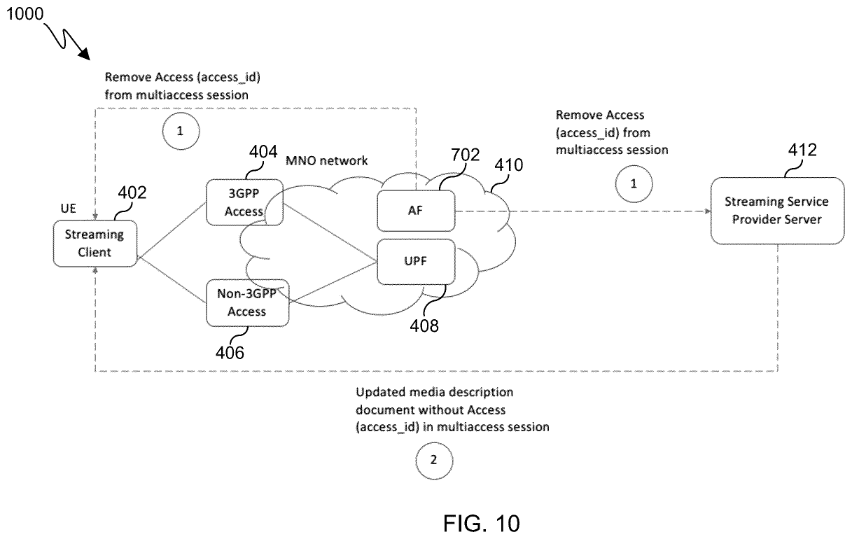

FIG. 10 illustrates an example process 1000 for network-initiated multi-access path management in accordance with this disclosure. The process 1000 illustrated in FIG. 10 is for illustration only. FIG. 10 does not limit the scope of this disclosure to any particular implementation of a process for network-initiated multi-access path management. For ease of explanation, the process 1000 of FIG. 10 may be described as being performed using the communication system 100 of FIG. 1. However, the process 1000 may be used with any other suitable system and using any other suitable electronic device(s).

As shown in FIG. 10, the process 1000 includes using the streaming client 402, the cellular access network 404, the non-cellular access network 406, the UPF 408, the MNO network 410, and the streaming service provider server 412, such as described with respect to FIG. 4. As also shown in FIG. 10, the MNO network 410 can also include the AF 702.

As shown in FIG. 10, the process 1000 includes, at a first step, the MNO network 410, via the AF 702, removing access, via removal of an access ID, to one of the access networks 404, 406 in a multi-access session for the streaming client 402. As shown in FIG. 10, the MNO network 410, via the AF 702, can, at the same time or near in time, also remove access, via removal of an access ID, to the one of the access networks 404, 406 in the multi-access session for the streaming service provider server 412. At a second step, the streaming service provider server 412 sends to the streaming client 402 an updated media description document, e.g., an MPD, without the removed access network, e.g., with the access ID.

For instance, MPTCP can perform better than TCP when the bandwidth on the two paths is constant and in cases where a secondary link with low bandwidth is added to the highly variable primary link. However, when an unstable secondary path is added to a stable primary path, MPTCP can perform worse. MPTCP is sensitive to bandwidth fluctuation which may cause streaming protocols such as DASH to underperform. In some cases, streaming protocols such as DASH benefit from the improved aggregated throughput provided by MPTCP; yet the inter-path throughput difference and intra-path throughput fluctuation can have noticeable (negative) impact when using MPTCP, resulting in lower bit rates or frequent rebuffering even if high bandwidth paths are available. To alleviate this, the process 1000 provides path management options with multi-access delivery of streaming media sessions.

Specifically, the process 1000 server to remove underperforming accesses. Steering functionalities such as those specified in 3GPP TS 23501 like MPTCP and MPQUIC attempt to utilize all paths for multi-access delivery. If one of the access networks is under-performing, because of the use of existing multi-access methodologies, the streaming client sees a reduced performing transport connection. Because of this, the streaming client reduces the demand e.g., by going to a lower media content component representation or adaptation. Instead of lowering the ask, however, the streaming client 402 may benefit if the underperforming access network is removed from the multi-access media delivery session. As a result of this, the remaining access networks in the multi-access session may provide an aggregate better QoS without the underperforming access network.

As shown in FIG. 10, to facilitate this functionality, the network entity, depending on per-access QoS metrics, may inform the streaming service provider and the UE to remove the underperforming access from the multi-access session. Depending on the agreements between the streaming service provider and the network, and based on UE subscription information and preferences, the network entity may initiate removing the access network from the multi-access streaming session. The streaming service provider may update the media description document (MPD) and send it to the UE without the underperforming access network. When the UE receives the updated MPD, and along with notification from network entity about removal of underperforming access network, it no longer requests media assets over that access network removes it from the UE resources.

Although FIG. 10 illustrates one example process 1000 for network-initiated multi-access path management, various changes may be made to FIG. 10. For example, the number and placement of various components of the process 1000 can vary as needed or desired. In addition, the process 1000 may be used in any other suitable process or other architectures, such as other architectures of this disclosure, and is not limited to the specific processes or architectures described above.

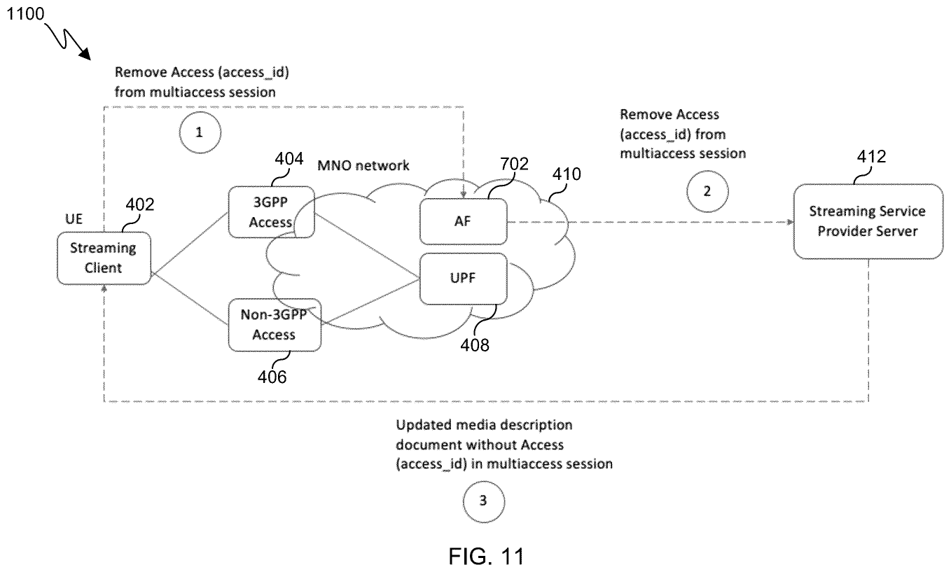

FIG. 11 illustrates an example process 1100 for client-initiated multi-access path management in accordance with this disclosure. The process 1100 illustrated in FIG. 11 is for illustration only. FIG. 11 does not limit the scope of this disclosure to any particular implementation of a process for client-initiated multi-access path management. For ease of explanation, the process 1100 of FIG. 11 may be described as being performed using the communication system 100 of FIG. 1. However, the process 1100 may be used with any other suitable system and using any other suitable electronic device(s).

As shown in FIG. 11, the process 1100 includes using the streaming client 402, the cellular access network 404, the non-cellular access network 406, the UPF 408, the MNO network 410, and the streaming service provider server 412, such as described with respect to FIG. 4. As also shown in FIG. 11, the MNO network 410 can also include the AF 702.

As shown in FIG. 11, the process 1100 includes, at a first step, the streaming client 402 initiating access removal of one of the access networks 404, 406 via a communication to the AF 702 of the network 410 to remove access, via removal of an access ID, to one of the access networks 404, 406 in a multi-access session. This causes, at a second step, the MNO network 410, via the AF 702, to send a communication to the streaming service provider server 412 to remove access, via removal of an access ID, to the one of the access networks 404, 406 in the multi-access session. At a third step, the streaming service provider server 412 sends to the streaming client 402 an updated media description document, e.g., an MPD, without the removed access network, e.g., with the access ID.

Thus, in some embodiments, the streaming client 402 may initiate the removal of an access network from a multi-access session by the streaming client 402 periodically performing QoS measurements. When the streaming client 402 notices that one of the access networks is under performing, it informs the network entity (AF 702) about removal of one or more access networks from the multi-access media streaming session. The network entity may inform the streaming service provider of the same information. The network entity may then interact with other network entities to drop the access network from the multi-access media streaming session, and the streaming service provider may provide an updated media description document to the UE after removing the underperforming access network. The UE can remove the access network connection on its end for the media streaming session.

The network entity, streaming service provider, and UE may later decide to add back the under-performing access to the media streaming session if per-access QOS information of the underperforming access network demonstrate a required improvement.

Although FIG. 11 illustrates one example process 1100 for client-initiated multi-access path management, various changes may be made to FIG. 11. For example, the number and placement of various components of the process 1100 can vary as needed or desired. In addition, the process 1100 may be used in any other suitable process or other architectures, such as other architectures of this disclosure, and is not limited to the specific processes or architectures described above.

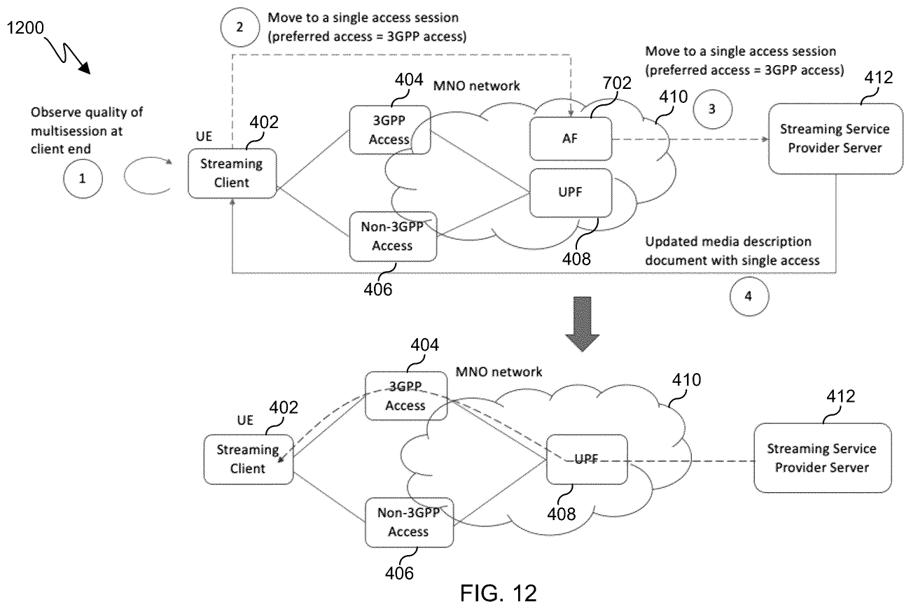

FIG. 12 illustrates an example process 1200 for switching from a multi-access session to a single access session in accordance with this disclosure. The process 1200 illustrated in FIG. 12 is for illustration only. FIG. 12 does not limit the scope of this disclosure to any particular implementation of a process for switching from a multi-access session to a single access session. For ease of explanation, the process 1200 of FIG. 12 may be described as being performed using the communication system 100 of FIG. 1. However, the process 1200 may be used with any other suitable system and using any other suitable electronic device(s).

As shown in FIG. 12, the process 1200 includes using the streaming client 402, the cellular access network 404, the non-cellular access network 406, the UPF 408, the MNO network 410, and the streaming service provider server 412, such as described with respect to FIG. 4. As also shown in FIG. 12, the MNO network 410 can also include the AF 702.

As shown in FIG. 12, instead of removing an underperforming access network, in various embodiments it may be feasible to move to a single-access session, i.e., a session utilizing one access network. To facilitate this, the process 1200, at a first step, includes the streaming client 402 observing the quality of the multi-access session from the client's perspective. At a second step, based on determining the quality of the multi-access session is below a threshold quality, the streaming client 402 conveys its preference to move to a single-access session to a network entity, e.g., the AF 702. In some embodiments, the streaming client 402 may also indicate its preferred access network and the amount of time such a move is requested.

At a third step, the network entity, depending on agreements with the streaming service provider server 412 and UE subscription information, may initiate moving from the multi-access session to a single-access session. In various embodiments, the network entity may either remove all other access networks other than the preferred access from the multi-access session, or terminate the whole multi-access session and re-setup the single access session with the preferred access network. At a fourth step, the streaming service provide server 412 provides an updated media description document with the single access information to the streaming client 402 and, as shown in FIG. 12, the multimedia session switches to a single access session.

Although FIG. 12 illustrates one example process 1200 for switching from a multi-access session to a single access session, various changes may be made to FIG. 12. For example, the number and placement of various components of the process 1200 can vary as needed or desired. In addition, the process 1200 may be used in any other suitable process or other architectures, such as other architectures of this disclosure, and is not limited to the specific processes or architectures described above.

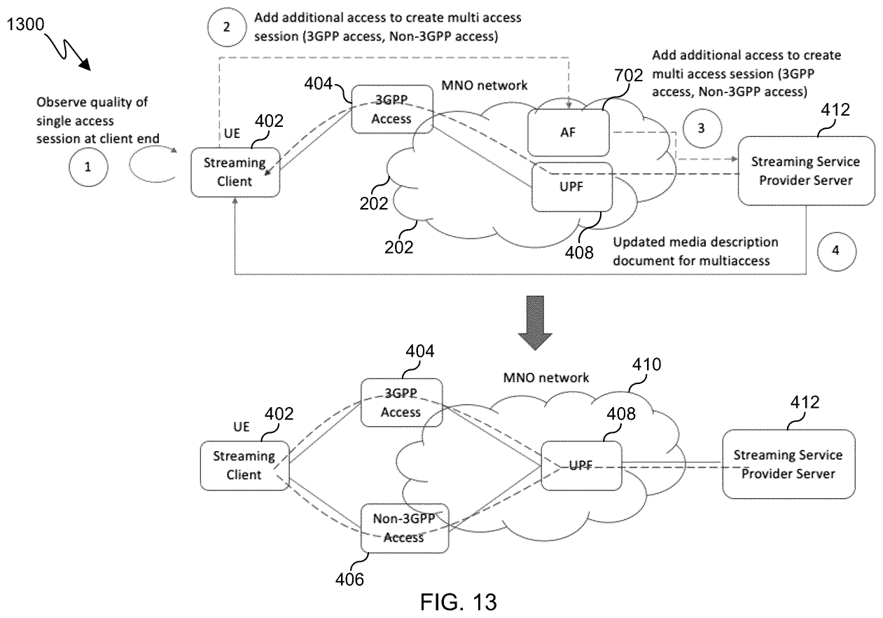

FIG. 13 illustrates an example process 1300 for switching from a single access session to a multi-access session in accordance with this disclosure. The process 1300 illustrated in FIG. 13 is for illustration only. FIG. 13 does not limit the scope of this disclosure to any particular implementation of a process for switching from a single access session to a multi-access session. For ease of explanation, the process 1300 of FIG. 13 may be described as being performed using the communication system 100 of FIG. 1. However, the process 1300 may be used with any other suitable system and using any other suitable electronic device(s).

As shown in FIG. 13, the process 1300 includes using the streaming client 402, the cellular access network 404, the non-cellular access network 406, the UPF 408, the MNO network 410, and the streaming service provider server 412, such as described with respect to FIG. 4. As also shown in FIG. 13, the MNO network 410 can also include the AF 702.

In various embodiments, any of the UE, network entity, and the streaming service provider may initiate the process of adding a new access network to an ongoing multi-access streaming session. Further, any of the UE, network entity, and the streaming service provider may initiate the procedure of moving an existing single-access media streaming session to a multi-access media streaming session by adding a new access network to the session.

If the streaming client 402 and/or the streaming service provider wants to add an access network, they can inform the network entity of such a migration. The network entity interacts with other entities in the network to provision a multi-access session. The UE and/or the streaming service provider may indicate their supported steering functionalities and steering modes for the soon-to-be-setup multi-access media streaming session. The network entity may then setup the multi-access session based on the recommendations from UE and streaming service provider, and agreements with the streaming service provider.

For example, as shown in FIG. 13, the process 1300, at a first step, includes the streaming client 402 observing the quality of an ongoing single access session from the client's perspective. At a second step, based on determining the quality of the single access session is below a threshold quality, the streaming client 402 conveys its preference to move to a multi-access session to a network entity, e.g., the AF 702. In some embodiments, the streaming client 402 may also indicate its preferred access network and the amount of time such a move is requested.

At a third step, the network entity, depending on agreements with the streaming service provider server 412 and UE subscription information, may initiate moving from the single access session to a multi-access session. In various embodiments, the network entity may either add additional access networks, or terminate the whole single access session and re-setup the multi-access session. At a fourth step, the streaming service provide server 412 provides an updated media description document with the multi-access information to the streaming client 402 and, as shown in FIG. 13, the multimedia session switches to a multi-access session.

Although FIG. 13 illustrates one example process 1300 for switching from a single access session to a multi-access session, various changes may be made to FIG. 13. For example, the number and placement of various components of the process 1300 can vary as needed or desired. In addition, the process 1300 may be used in any other suitable process or other architectures, such as other architectures of this disclosure, and is not limited to the specific processes or architectures described above.

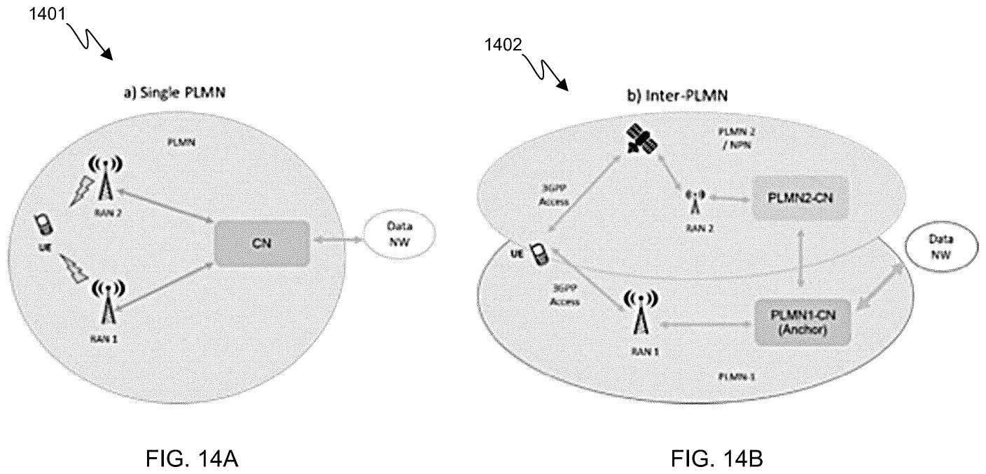

FIG. 14A illustrates an example intra-public land mobile network (PLMN) scenario 1401 and FIG. 14B illustrates an example inter-PLMN scenario 1402 in accordance with this disclosure. The scenarios 1401, 1402 illustrated in FIGS. 14A and 14B are for illustration only. FIGS. 14A and 14B do not limit the scope of this disclosure to any particular scenarios. For ease of explanation, the scenarios 1401 and 1402 may be described as using the communication system 100 of FIG. 1. However, the scenarios 1401, 1402 may be used with any other suitable system and using any other suitable electronic device(s).

The Application Function (AF), Access and Mobility Function (AMF), Policy Control Function (PCF), Session Management Function (SMF), and User Plane Function (UPF) described in this disclosure can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain critical functions may be executed by hardware components to achieve high performance, while other functions may be performed by software modules to provide flexibility and ease of updates.

The example scenarios 1401 and 1402 shown in FIGS. 14A and 14B provide examples of intra-PLMN and inter-PLMN scenarios for using multiple access networks.

As shown FIGS. 14A and 14B, a UE is connected to more than one access network at the same time. Traffic from different applications installed on the UE may use one or more access networks to connect to their service endpoints, either inside the operator network, or through the operator network into the external Internet. The type of access networks is not only limited to terrestrial mobile networks, but could also be satellite networks, non-public networks (NPNs), etc.

There are potential architecture and system level enhancements for the 5G system to support the operation of the DualSteer device that is capable of traffic steering and switching of user data for different services across two 3GPP access networks.

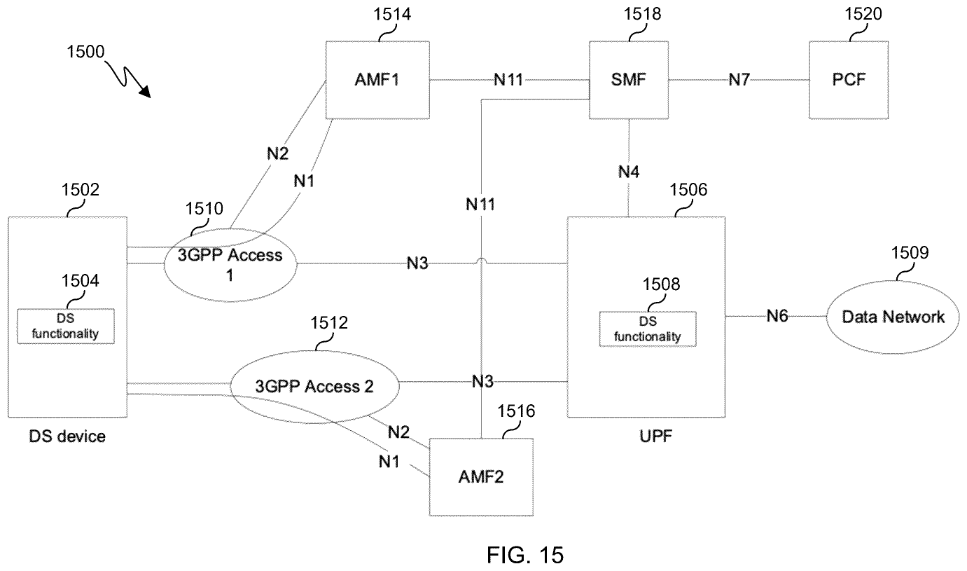

FIG. 15 illustrates an example dual steering architecture 1500 in accordance with this disclosure. The dual steering architecture 1500 illustrated in FIG. 15 is for illustration only. FIG. 15 does not limit the scope of this disclosure to any particular implementation of a dual steering architecture. For ease of explanation, the architecture 1500 of FIG. 15 may be described as being performed using the communication system 100 of FIG. 1. However, the architecture 1500 may be used with any other suitable system and using any other suitable electronic device(s).

FIG. 15 shows a DualSteer (DS) device 1502 connected to operator network using two 3GPP access networks. Multiple variations of the architecture 1500 with roaming in one or more access networks are also possible. As shown in FIG. 15, a dual steering functionality (DS functionality) 1504 inside the DS device 1502 allows connection to an operator network UPF 1506 (connected to data network 1509), with its own DS functionality 1508, using multiple 3GPP access networks 1510, 1512. As shown in FIG. 15, the architecture 15 also includes a first AMF 1514, a second AMF 1516, an SMF 1518, and a PCF 1520.

With dual steering functionality, the network may see that it is interacting with two different 3GPP UE endpoints when in fact it is the same UE that has credentials to access content over multiple access networks. The DS functionalities 1504, 1508 enables separate registration and UE session management over each of the connected 3GPP access networks. With DualSteer and multipath delivery as shown in FIG. 15, clients are able to use the capabilities of two or more access networks to connect to application service endpoints (or application servers) through the operator network.

Although FIG. 15 illustrates one example dual steering architecture 1500, various changes may be made to FIG. 15. For example, the number and placement of various components of the architecture 1500 can vary as needed or desired. In addition, the architecture 1500 may be used in any other suitable process or other architectures, such as other architectures of this disclosure, and is not limited to the specific processes or architectures described above.

In this disclosure, architectures and procedures are described with one or more access networks. Sometimes, the one or more access networks are described as being 3GPP access and non-3GPP access. However, it will be understood that all the aspects in this disclosure equally apply to any of multiple types of access networks.

Clause 5.32 of TS 23.501 specifies support for ATSSS. The ATSSS architecture provides a basis for the dual steer architecture, such as that shown in FIG. 15. The ATSSS architecture specifies how the UE and the network exchange ATSSS rules (from the network to the UE) and N4 rules (in the network) are configured to enable multi-access traffic steering, switching, and splitting. Defined as part of the ATSSS architecture are steering functionalities and steering modes.

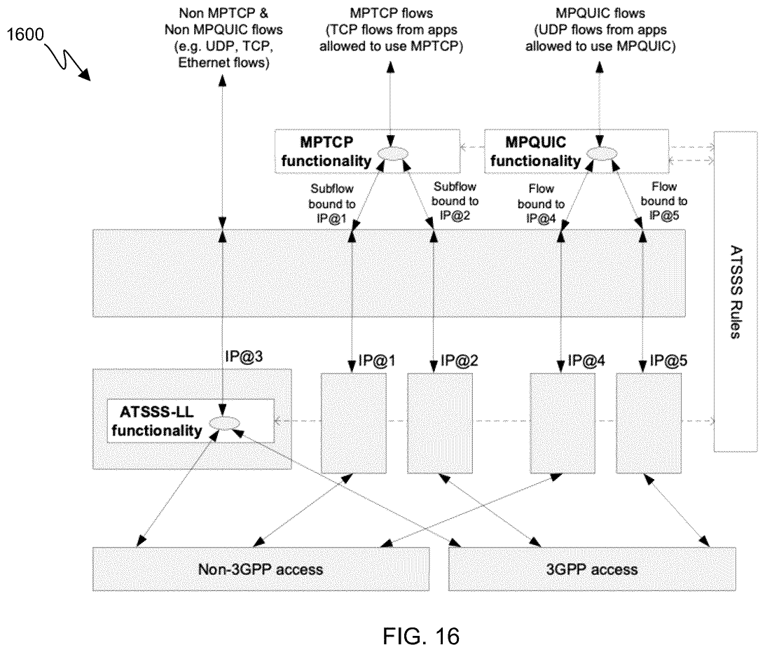

For example, FIG. 16 illustrates example steering functionalities 1600 in a UE model as specified in ATSSS architecture.

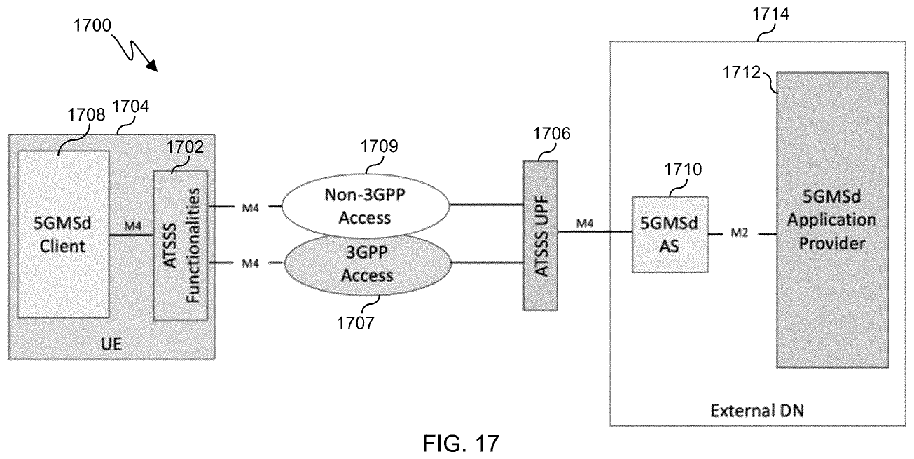

FIG. 17 illustrates an example multi-access media delivery architecture 1700 in accordance with this disclosure. The multi-access media delivery architecture 1700 illustrated in FIG. 17 is for illustration only. FIG. 17 does not limit the scope of this disclosure to any particular implementation of a multi-access media delivery architecture. For ease of explanation, the architecture 1700 of FIG. 17 may be described as being performed using the communication system 100 of FIG. 1. However, the architecture 1700 may be used with any other suitable system and using any other suitable electronic device(s).

The architecture 1700 demonstrates the collaboration scenario for multi-access media delivery using ATSSS. In this scenario, the multi-access delivery is supported by ATSSS functionalities 1702 in a UE 1704 and in a UPF 1706. The ATSSS functionalities in the UE 1704 and the UPF 1706 in an MNO network are responsible for steering, switching, and splitting of M4 media application flows between at least one 3GPP access network 1707 and at least one non-3GPP access network 1709. An 5GMSd client 1708 in the UE 1704 and the 5GMSd AS 1710 of a 5GMSd application provider server 1712 in an external distribution network 1714 (e.g., a CDN) may be unaware of multi-access media delivery.

Although FIG. 17 illustrates one example multi-access media delivery architecture 1700, various changes may be made to FIG. 17. For example, the number and placement of various components of the architecture 1700 can vary as needed or desired. In addition, the architecture 1700 may be used in any other suitable process or other architectures, such as other architectures of this disclosure, and is not limited to the specific processes or architectures described above.

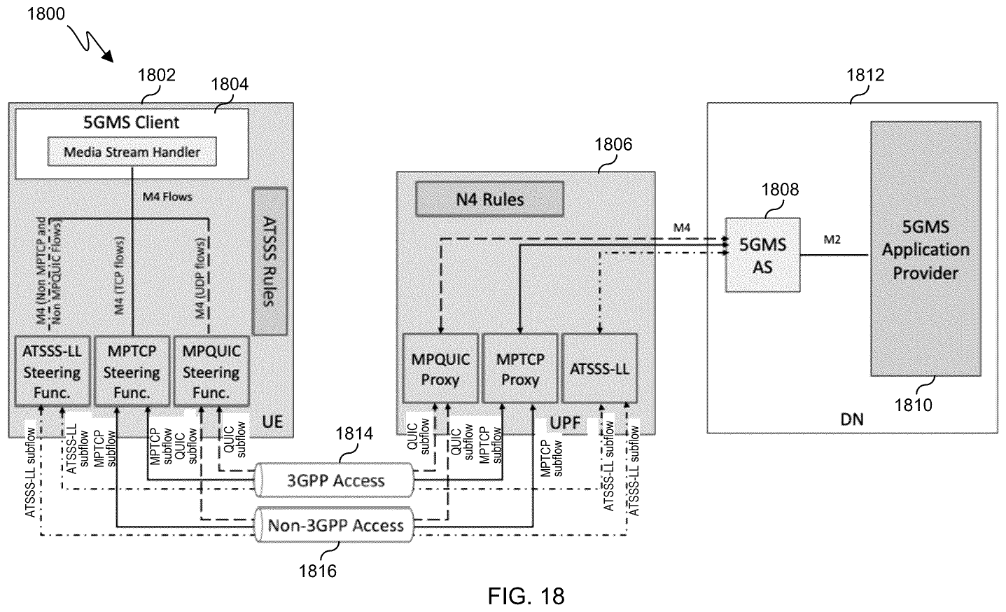

FIG. 18 illustrates another example multi-access media delivery architecture 1800 in accordance with this disclosure. The multi-access media delivery architecture 1800 illustrated in FIG. 18 is for illustration only. FIG. 18 does not limit the scope of this disclosure to any particular implementation of a multi-access media delivery architecture. For ease of explanation, the architecture 1800 of FIG. 18 may be described as being performed using the communication system 100 of FIG. 1. However, the architecture 1800 may be used with any other suitable system and using any other suitable electronic device(s).

3GPP TS 26.501 specifies a media streaming architecture where in an application (5GMS Aware App-5G Media Streaming Aware App) uses the services of a 5GMS Client (5G Media Streaming Client) that provides media session handling and media streaming handling capabilities to the 5GMS Aware App. Media session handling capabilities help with signaling information with 5G Media streaming services in the network, and the media stream handling capabilities help transmit and receive media content from/to media streaming servers (e.g., a 5GMS AS-5G Media Streaming Application Server) in the network.

FIG. 18 shows a detailed collaboration scenario for multi-access media delivery using different ATSSS steering functionalities. As shown in FIG. 18, a UE 1802 with a 5GMS client 1804 is connected to a network entity, e.g., a UPF 1806. The UE 1802 and the network may negotiate the use of one or more ATSSS steering mechanisms. For example, if the UE 1802 and the network agree on using the low-layer steering mechanism (ATSSS-LL) as specified in clause 5.32 of TS 23.501, the 5GMS client 1804 and a 5GMS AS 1808 provided by a 5GMS application provider 1810 of a distribution network 1812 (e.g., a CDN) are unaware of multi-access media delivery.

Traffic steering, switching, and splitting decisions at the UE 1802 and UPF 1806 can be based on information at the IP layer and below. A data switching function in the UE 1802 decides how to steer, switch, and split M4 flows across a 3GPP access network 1814 and a non-3GPP access network 1816 based on provisioned ATSSS rules and local conditions (e.g., signal loss conditions). Any type of traffic, including TCP traffic, UDP traffic, Ethernet traffic, etc. from the 5GMS Client 1804 may be steered, switched, or split.

If the UE 1802 and the network agree on using a high-layer MPTCP steering mechanism, such as specified in clause 5.32.6.2.1 of TS 23.501, the 5GMS Client 1804 and the 5GMS AS 1808 may be unaware of multi-access media delivery. Traffic steering, switching, and splitting decisions at the UE 1802 and UPF 1806 are based on information at the IP layer and above. The network lenables an MPTCP proxy in the UPF 1806 for the multi-access PDU Session.

The network can allocate three IP addresses/prefixes to the UE 1802—one for the multi-access PDU Session and two additional IP addresses/prefixes called “MPTCP link-specific multipath” addresses associated with each of the 3GPP and non-3GPP Accesses. The “MPTCP link-specific multipath” addresses may not be routable via N6. TCP application flows at reference point M4 from a media stream handler of the 5GMS client 1804 in a UE 1802 allowed to use MPTCP functionality are sent to the MPTCP proxy over the two access networks 1814, 1816 using the two link-specific multipath addresses, and the MPTCP proxy functionality in the UPF 1806 uses the multi-access PDU Session IP address/prefix to communicate with the 5GMS AS 1808 in the distribution network 1812. Any non-MPTCP traffic from the 5GMS client 1804 is routed over either the 3GPP access network 1814 or the non-3GPP access network 1816 based on a received ATSSS rule for non-MPTCP traffic, such as specified in clause 5.32.2 of TS 23.501.

If the UE 1802 and the network agree on using the high-layer MPQUIC steering mechanism, such as specified in clause 5.32.6.2.2 of TS 23.501, the 5GMS client 1804 and the 5GMS AS 1808 may be unaware of multi-access media delivery. Traffic steering, switching, and splitting decisions at the UE 1802 and UPF 1806 are based on information at the IP layer and above. The network enables an MPQUIC proxy in the UPF 1806 for the multi-access PDU Session. The network allocates three IP addresses/prefixes to the UE 1802—one IP for the multi-access PDU Session and two additional IP addresses/prefixes called “MPQUIC link-specific multipath” addresses associated with each of the 3GPP and non-3GPP Accesses. The “MPQUIC link-specific multipath” addresses may not be routable via N6. A QoS Flow selection and steering mode selection component in the media stream handler of the 5GMS client 1804 determines the number of multipath QUIC connections to be set up for the application flows at reference point M4. Each QUIC connection carries one QoS flow (based on QoS rules) i.e., each multipath QUIC connection carries the UDP traffic mapped to a single QoS flow. QUIC-based UDP application flows at reference point M4 from the media stream handler of a 5GMS client 1804 are sent over the two access networks 1814, 1816 to the MPQUIC proxy using the two link-specific multipath addresses with multiple QUIC paths, and the MPQUIC proxy functionality in the UPF 1806 uses the multi-access PDU Session IP address/prefix to communicate with the 5GMS AS 1808 in the distribution network 1812.

Although FIG. 18 illustrates one example multi-access media delivery architecture 1800, various changes may be made to FIG. 18. For example, the number and placement of various components of the architecture 1800 can vary as needed or desired. In addition, the architecture 1800 may be used in any other suitable process or other architectures, such as other architectures of this disclosure, and is not limited to the specific processes or architectures described above.

There can be dynamic policies in 5G media streaming. For example, 3GPP TS 26.501 and TS 26.510 specify stage-2 procedures and stage-3 data model definitions for the dynamic policy feature in 5G Media Streaming. Specified as part of a high-level procedure for service provisioning in clause 5.3.2 of TS 26.501, when the dynamic policy feature is offered and selected, the 5GMSd Application Provider specifies a set of policies which can be invoked for the media streaming session. The data model for the PolicyTemplate resource in specified in clause 8.7.3 of TS 26.510. The Media Session Handler becomes aware of the selected policies in the form of a list of valid Policy Template Ids listed in the Service Access Information it obtains from the 5GMS AF at reference point M5 or by private means via reference point M8.

When the Media Session Handler intends to activate a Dynamic Policy for a media streaming session, the Media Session Handler sends a Dynamic Policy API request to the 5GMS AF. As specified in clause 5.7.3 of TS 26.501, the request includes at least the Provisioning Session identifier, the Service Data Flow Description(s) of the relevant application flow(s) and the Policy Template identifier to be applied to the described application flow(s). The details of the Dynamic Policy API are specified in clause 9.3 of TS 26.510, and the data model for the DynamicPolicy resource is specified in clause 9.3.3 of TS 26.510.

The applicationFlowBindings property in the DynamicPolicy data model specifies the bindings between application flows at reference point M4 managed within the scope of the Dynamic Policy Instance and their network QoS requirements. The ApplicationFlowBinding object referenced by this property includes three sub-properties that allow for specification of the application flows to which the dynamic policy QoS specification is to be applied:
componentIdentifier that references a particular service component in the Policy Template
applicationFlowDescription which provides a specification of an application flow to be used by the 5G Core for application traffic identification purposes.
qosSpecification that provides network QoS requirements for the application flow(s) described by applicationFlowDescription.

The ApplicationFlowDescription type referenced by the applicationFlow Description property is specified in clause 7.3.3.2 of TS 26.510 and includes the following sub-properties:
filterMethod of type SdfMethod (specified in clause 7.3.4.2 of TS 26.510) provides details about how to identify packets belonging to this application flow.
packetFilter of type IPPacketFilterSet (specified in clause 7.3.3.1 of TS 26.510) provides the details about the application flow in terms of packet header values.
domainName describes the application flow in terms of the FQDN of a Media AS.
mediaType describes the type of media carried by this application flow.
mediaTransportParameters of type ProtocolDescription describes the set of media transport protocol parameters to be used by the 5G Core for the purpose of PDU Set identification and/or end of data burst detection on this application flow.

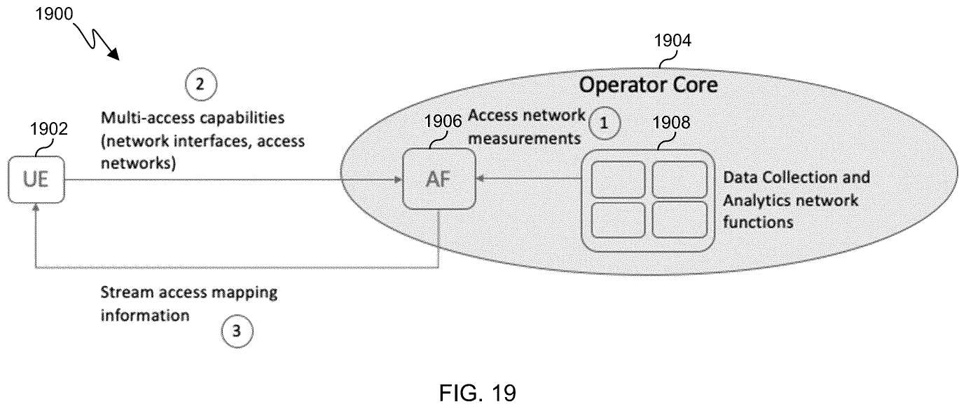

FIG. 19 illustrates an example stream mapping process 1900 in accordance with this disclosure. The process 1900 illustrated in FIG. 19 is for illustration only. FIG. 19 does not limit the scope of this disclosure to any particular implementation of a stream mapping process. For ease of explanation, the process 1900 of FIG. 19 may be described as being performed using the communication system 100 of FIG. 1. However, the process 1900 may be used with any other suitable system and using any other suitable electronic device(s).

As shown in FIG. 19, the process 1900 involves a UE 1902 and an operator core 1904. The operator core 1904 includes a network entity or apparatus, e.g., an AF 1906 and data collection and analytics network functions 1908. The process 1900 provides an example of application bootstrapping for multi-access media delivery. In various embodiments, an apparatus in the network such as the AF 1906 may send service access information to the UE 1902, such as either to a 5GMS Aware App or a 5GMS client. The service access information possesses information for the UE 1902 media client to connect to and receive media content from an application server (e.g., 5GMS AS) in the network.

ATSSS rules help the UE 1902 determine which network interface/access networks in the UE 1902 are eligible for communicating with entities in the network. This information along with the mapping information enables the selection of correct stream delivery option over specific network interfaces/access networks.

For example, as shown in FIG. 19, at a first step the AF 1906 (or other network entity) receives access network measurements using the data collection and analytics network functions 1908 of the operator core 1904. At a second step, the UE 1902 provides to the AF 1906 multi-access capabilities information, which can include information on network interfaces, access networks, etc. At a third step, the AF 1906 sends stream access mapping information to the UE 1902.

When the network apparatus (e.g., the AF 1906) sends the stream access mapping information to the UE 1902, the UE 1902 uses the stream access mapping information to upload/download/stream a specific media stream from the application server in the network over the specific network interface/access.

As described above, to enable the AF 1906 to provide the above mapping, the UE 1902, at the second step, may send its capabilities for multi-access delivery including sending the list of network interfaces/access networks that it is capable of using to communicating with the application server in the network. The AF 1906 may receive information from other network entities about detailed performance statistics of each of the access networks that the UEs may use to send/receive traffic. From this information, the AF 1906 may derive the optimum configuration of which media stream to the sent/received over which access network. In various embodiments of this disclosure, the service access information may be enhanced to include the following service access mapping information shown in Table 7 to enable multi-access media delivery between the UE and the network.

TABLE 7

| Information Element | Description |
|---|---|
| Stream_access_mapping | Mapping between different streams of the media service |
| | for one or more network interfaces and/or access |
| | networks on the UE. |
| | Each element in this collection is the form of a <key, |
| | value> pair where “key” represents the media stream |
| | identifier and “value” represents a list of access |
| | networks and/or interfaces through which the UE is to |
| | transmit/receive media content to/from the application |
| | server in the network. |
| enable_steering_functionality | Indicates which streaming functionality specified in |
| | 3GPP TS 23501 is to be enabled for multi-access media |
| | delivery. Possible values of this filed include the |
| | following: |
| | ATSSS-LL: ATSSS low layer functionality |
| | specified in 3GPP STS 23501 |
| | MPTCP: MPTCP functionality specified in |
| | 3GPP STS 23501 |
| | MPQUIC: MPQUIC functionality specified in |
| | 3GPP STS 23501 |
| | When the UE App (5GMS Aware App) or the 5GMS |
| | client receives this information from the network |
| | apparatus, the UE application enables the requested |
| | steering functionalities in the UE as described earlier in |
| | the disclosure. |

Although FIG. 19 illustrates one example stream mapping process 1900, various changes may be made to FIG. 19. For example, the number and placement of various components of the process 1900 can vary as needed or desired. In addition, the process 1900 may be used in any other suitable process or other architectures, such as other architectures of this disclosure, and is not limited to the specific processes or architectures described above.

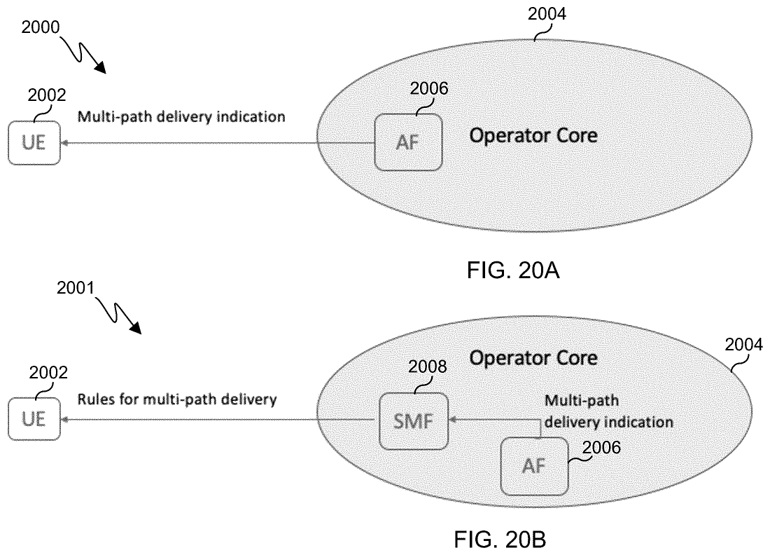

FIGS. 20A and 20B illustrate example multi-path delivery indication processes 2000 and 2001 in accordance with this disclosure. The processes 2000 and 2001 illustrated in FIGS. 20A and 20B are for illustration only. FIGS. 20A and 20B do not limit the scope of this disclosure to any particular implementation of a multi-path delivery indication process. For ease of explanation, the processes 2000 and 2001 of FIGS. 20A and 20B may be described as being performed using the communication system 100 of FIG. 1. However, the processes 2000 and 2001 may be used with any other suitable system and using any other suitable electronic device(s).

As shown in FIGS. 20A and 20B, the processes 2000 and 2001 involve a UE 2002 and an operator core 2004. The operator core 2004 includes a network entity or apparatus, e.g., an AF 2006. The UE 2002 may receive multi-path delivery notification/information to enable multi-path delivery, which can be triggered in different ways as shown in FIGS. 20A and 20B.

For example, as shown in FIG. 20A, in some embodiments, the process 2000 includes using an application notification to trigger multi-path delivery from the UE 2002. The network apparatus entity (e.g., the AF 2006) informs the UE 2002 using application level signaling that service performance of the UE 2002 may improve if the UE 2002 switches or modifies to/from multi-path delivery. Further, the network apparatus may provide additional information to help the UE 2002 enable multi-path delivery. The AF 2006, for example, may use M5 signaling to provide this information to the UE. When the UE 2002 receives this information from the AF 2006, it initiates multi-path delivery using a multi-path steering functionality such as those specified in TS 23501 (e.g., ATSSS Low Layer/MPTCP/MPQUIC) suggested by the AF 2006.

As shown in FIG. 20B, in some embodiments, the process 2001 uses an application feedback to trigger network-based initiation for multi-path delivery. The network apparatus (e.g., the AF 2006) may provide application feedback to other network entities (e.g., a PCF or SMF 2008) to enable multi-path delivery for one or more UEs. The SMF/PCF 2008 will then use signaling mechanisms, such as those specified in TS 23501, to provide ATSSS rules and N4 rules to UE 2002 and AF 2006, respectively. When the UE 2002 receives ATSSS rules, it tries to follow the guidance in those rules to switch to/from multi-path delivery or modify existing multi-path delivery procedures.

For either of the above options described with respect to FIGS. 20A and 20B, the following information in Table 8 may be provided by the AF 2006 to network entities or the UE 2002 to help with multi-path delivery.

TABLE 8

| Option | Description |
|---|---|
| Change steering functionality | AF suggests the UE move to a different functionality than the |
| | current steering functionality. If the UE is using any one of |
| | the current steering functionalities (e.g., ATSSS-LL, MPTCP, |
| | MPQUIC specified in 3GPP TS 23501), the AF may |
| | recommend the UE to switch to a different steering |
| | functionality. |
| | For example, if the UE is currently using ATSSS-LL steering |
| | functionality which does not consider any application specific |
| | needs/optimizations during multi-path delivery, then the AF |
| | may see that the UE performance may benefit by switching to |
| | better steering functionality (e.g. MPQUIC) that allows for |
| | more application controlled multi-path delivery. |
| | When this option is indicated to the UE, the UE initiates the |
| | process of switching to a different steering functionality |
| | thereby allowing optimization with multi-path delivery |
| Add sub-flow/path | When the AF sees that the UE is using MPTCP multi-path |
| | delivery, the AF may suggest to add an additional sub-flow to |
| | existing session to improve service performance. |
| | When the AF sees that the UE is using MPQUIC multi-path |
| | delivery, the AF may suggest to add an additional path or |
| | MPQUIC connection to existing session to improve service |
| | performance. |
| | In either of the above options, the AF may optionally provide |
| | the network interface or access information over which this |
| | sub-flow/path is to be added. To allow for providing this |
| | information, the AF may receive information from other |
| | network elements about performance of different access |
| | networks from the UE. The UE may also provide the |
| | available network interfaces/access networks it can connect to |
| | as described earlier in the disclosure. |
| Remove sub-flow/path | When the AF sees that the UE is using MPTCP multi-path |
| | delivery, the AF may suggest to remove an existing sub-flow |
| | in the session to improve service performance. |
| | When the AF sees that the UE is using MPQUIC multi-path |
| | delivery, the AF may suggest to drop a path or MPQUIC |
| | connection in the session to improve service performance. |
| | In either of the above options, the AF may provide the |
| | network interface or access information over which the sub- |
| | flow/path is to be removed. To allow for providing this |
| | information, the AF may receive information from other |
| | network elements about performance of different access |
| | networks from the UE. |
| Switch sub-flow/path | When the AF sees that the UE is using MPTCP multi-path |
| | delivery, the AF may suggest to switch an existing sub-flow |
| | over one access network to another access network to |
| | improve service performance. |
| | When the AF sees that the UE is using MPQUIC multi-path |
| | delivery, the AF may suggest to switch a path or MPQUIC |
| | connection from one access network to another access |
| | network to improve service performance. |
| | In either of the above options, the AF may provide the |
| | network interface/access information over which the sub- |
| | flow/path is to be switched from and the network |
| | interface/access information over which the sub-flow/path is |
| | to be switched to. |
| | To allow for providing this information, the AF may receive |
| | information from other network elements about performance |
| | of different access networks that the UE has currently access to. |
| Split sub-flow/path | The AF may see that the UE performance benefits if the UE |
| | splits the traffic over an existing MPTCP sub-flow/MPQUIC |
| | connection to another MPTCP sub-flow/MPQUIC |
| | connection. The AF may share this information to the UE |
| | (using any of the two ways described earlier in the |
| | disclosure). |
| | To facilitate this split, the AF may provide the MPTCP sub- |
| | flow/MPQUIC connection information that is to be split, the |
| | network interface/access network where the split traffic is to |
| | be additionality carried/sent over, and the traffic split criteria |
| | (e.g., percentage split/application specific split information |
| | such as beginning of video GOPS, start of I frame etc.) |
| | To allow for providing this information, the AF may receive |
| | information from other network elements about performance |
| | of different access networks that the UE has currently access to. |
| Number of sub-flows/paths | The AF may inform the UE directly or indirectly using the |
| | methods described earlier in the disclosure about the number |
| | of MPTCP sub-flows or MPTCP paths/connections have to be |
| | used for multi-path. The AF may also indicate one or more |
| | network interfaces/access networks these MPTCP sub- |
| | flows/MPQUIC paths and/or connections have to be set up over. |
| Add network-interface | The AF may inform the UE to add a network interface over a |
| | specific access network to reach the Application Server in the |
| | MNO network. The network-interface may be added on an |
| | existing access network through which the UE is accessing |
| | services of Application Server, or may be recommended to be |
| | added over a new access network over which there is no |
| | existing session into the MNO network. In the latter case, if |
| | the UE is recommended to add a network interface over an |
| | access network over which there is no existing connection to |
| | MNO network, the UE may prompt to the user about such a |
| | requirement, and it is up to the user whether or not to add a |
| | new interface over the suggested access network. |
| | To support this option, the AF may provide the access |
| | network over which the network interface is to be connected to. |
| Remove network interface | The AF may inform the UE to remove an existing network |
| | interface over a specific access network to avoid reaching the |
| | Application Server in the MNO network over that network |
| | interface. This may be recommended by the AF to avoid the |
| | state machine/stack implementation of MPTCP/MPQUIC to |
| | automatically use the problematic network interface for multi- |
| | path delivery processes. |
| Keep alive sub-flow/path | The AF may inform the UE about keeping an MPTCP sub- |
| | flow or MPQUIC path/connection alive if it is not currently |
| | being used for media delivery. The AF may include details |
| | about how long to keep the sub-flow or connection active |
| | using the keep alive process. |

When the UE 2002 receives the above multi-path delivery notification information, the UE 2002 may set up or teardown multi-path delivery sessions, or modify existing sessions to multi-path delivery as described in the various embodiments of this disclosure.

Although FIGS. 20A and 20B illustrate example multi-path delivery indication processes 2000 and 2001, various changes may be made to FIGS. 20A and 20B. For example, the number and placement of various components of the processes 2000 and 2001 can vary as needed or desired. In addition, the processes 2000 and 2001 may be used in any other suitable process or other architectures, such as other architectures of this disclosure, and is not limited to the specific processes or architectures described above.

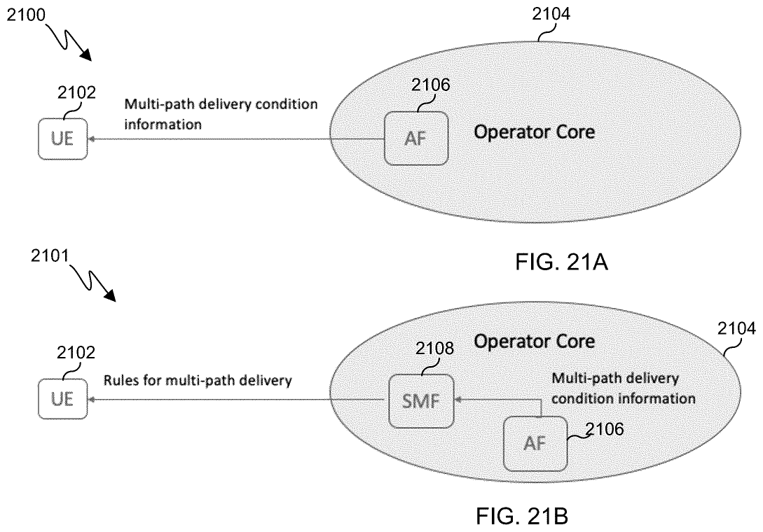

FIGS. 21A and 21B illustrate example multi-path delivery condition information processes 2100 and 2101 in accordance with this disclosure. The processes 2100 and 2101 illustrated in FIGS. 21A and 21B are for illustration only. FIGS. 21A and 21B do not limit the scope of this disclosure to any particular implementation of a multi-path delivery condition information process. For ease of explanation, the processes 2100 and 2101 of FIGS. 21A and 21B may be described as being performed using the communication system 100 of FIG. 1. However, the processes 2100 and 2101 may be used with any other suitable system and using any other suitable electronic device(s).

As shown in FIGS. 21A and 21B, the processes 2100 and 2101 involve a UE 2102 and an operator core 2104. The operator core 2104 includes a network entity or apparatus, e.g., an AF 2106. In addition to a UE receiving multi-path delivery notification as described with respect to FIGS. 20A and 20B, the UE 2102 may also be provided with condition information on when to enable or disable multi-path delivery. As described in this disclosure, the network apparatus entity (e.g., the AF 2106) may send this information in multiple ways.

For example, as shown in FIG. 21A, the process 2100 includes sending the condition information directly to the UE 2102 (e.g., using an M5 API, such as specified in 3GPP TS 26.501 and 3GPP TS 26.510). When such information is sent directly to the UE 2102, the UE 2102 may initiate the multi-path delivery process as suggested by the AF 2106.

As another example, as shown in FIG. 21B, the process 2101 includes sending the condition information to a PCF/SMF 2108 in the network. The PCF/SMF 2108 may translate this information into routing and forwarding rules at the UE (ATSSS rules) and the UPF (N4 rules). Such a translation may be requested by the AF 2106 to happen when the AF 2106 intends to have the UE 2102 enable or disable the multi-path delivery process.

In either of above cases, if the AF 2106 intends to activate multi-path delivery process, the AF 2106 may include additional information as described in this disclosure, and any other information related to which access network and/or network interface to use for multi-path delivery. Alternatively, if the AF 2106 intends to disable multi-path delivery, the AF 2106 may include information about which access network/network interface to be disabled.

In various embodiments, the following condition information in Table 9 may be sent to the UE 2102 or PCF/SMF 2108 by the AF 2106.

TABLE 9

| Information element | Description |
|---|---|
| Enable time | The AF may indicate the time when to enable multi-path |
| | delivery over one or more access networks |
| Disable time | The AF may indicate the time when to disable multi-path |
| | delivery over one or more access networks. The AF may |
| | optionally send the identifiers of one or more access networks |
| | over which the media delivery is to be stopped. |
| Access-network-list | List of access networks to use for multi-path delivery |
| Connection-metrics-map | Map of connection metrics. Each element in the map is of the |
| | form <key, value> pair where key represents a connection |
| | metric and the value represents an object with two parameters: |
| | threshold/range of acceptable values for the metric |
| | action to perform if the connection metric value |
| | exceeds the threshold or not in the given range |
| | When the UE receives this map information, it may measure |
| | the connection metric when the service content is being |
| | delivered and compare the measure value to the given |
| | threshold/range information. If the measured value is less than |
| | the threshold or within the given range, the delivery continues |
| | as is. However, if the measured value is greater than the |
| | threshold or outside the given range, then the UE performs the |
| | corresponding action in the value object. |
| | The action information could be any of the follows: |
| | do-nothing: no change to the current delivery |
| | mechanism |
| | disable-multi-path-delivery: Disable multi-path |
| | delivery for the service and switch to single-path- |
| | delivery mode |
| | change steering functionality as described earlier in the |
| | disclosure |
| | add sub-flow/path as described earlier in the disclosure |
| | remove sub-flow/path as described earlier in the |
| | disclosure |
| | switch sub-flow/path as described earlier in the |
| | disclosure |
| | split sub-flow/path as described earlier in the disclosure |
| | add-network-interface as described earlier in the |
| | disclosure |
| | remove-network-interface as described earlier in the |
| | disclosure |

Although FIGS. 21A and 21B illustrate example multi-path delivery condition information processes 2100 and 2101, various changes may be made to FIGS. 21A and 21B. For example, the number and placement of various components of the processes 2100 and 2101 can vary as needed or desired. In addition, the processes 2100 and 2101 may be used in any other suitable process or other architectures, such as other architectures of this disclosure, and is not limited to the specific processes or architectures described above.

3GPP TS 26.501 and 3GPP TS 26.510 describe the procedures and data model definitions for policy management and network assistance aspects with media delivery. 3GPP TS 26.501 and 3GPP TS 26.510 describe policy management aspects where the UE may request the network apparatus entity (e.g., AF) to apply a given policy or QoS treatment to media application flows. The QoS treatment could be in the form of defining any of the below QoS parameters
Bit rates: Media application traffic bit rate. In either the downlink direction or uplink direction or both.
Packet latency: Media application traffic packet latency. In either the downlink direction or uplink direction or both.
Packet loss rate: Media application traffic packet loss rate. In either the downlink direction or uplink direction or both.
PDUSet QoS parameters in either the downlink direction or uplink direction or both.

When the AF receives such a policy request from the UE, the AF works with other network entities in the network to provide the requested QoS to the media application flows of the UE. 3GPP TS 26.501 and 3GPP TS 26.510 describe network assistance feature where in the UE may request the network for bandwidth estimation (so it can adapt its offering to end user accordingly) or a temporary boost in bandwidth/throughput (to its media application flows) so it can for example re-fill network buffers.

For either of the above two procedures, when the media service is being run on a multi-access session where in multiple paths are being used over multiple access networks, the following steps may be included in the existing procedures to support multi-access delivery:
When the UE requests QoS treatment to specific media application flows, it is possible that one or more media application flows are being transmitted over multiple paths/access networks with different QoS possibilities and constraints. To support policy management feature described above, existing procedure may be enhanced to include specific access network/MPQUIC path/MPQUIC connection/MPTCP sub-flow/ATSSS-LL sub-flow over which the QoS treatment is sought by the UE. For example, if a media stream is split and delivered over two different access networks (access-network-A and access-network-B), then while requesting for QoS treatment, the UE includes specific access network information/network interface information/path or sub-flow over which the QoS treatment/enhancement is sought. When this information is received by the AF, it works with other network entities in the network to satisfy the QoS treatment requests. The AF may then inform the UE about whether its policy adjustment request is accomplished, or there was a problem in doing so.
When the UE requests for network assistance as described above, it may additionally include the specific access network/network interface over which it intends to receive the bandwidth estimation or temporary network boost. When the AF receives a network assistance request with such additional information, the AF works with other network entities to facilitate assistance to the UE over specific access networks/network interfaces/paths/sub-flows. The AF may then inform the UE about whether its policy adjustment request is accomplished, or there was a problem in doing so.

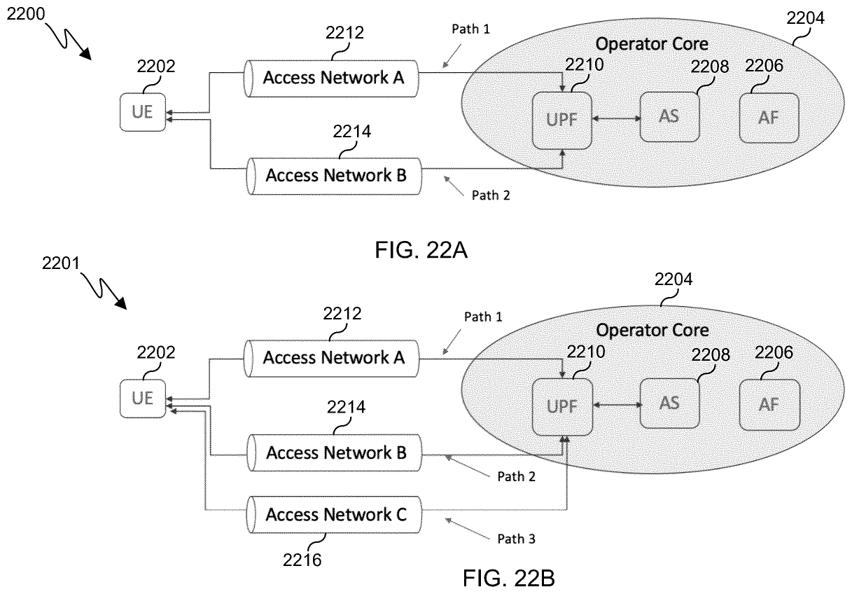

FIGS. 22A and 22B illustrate example processes 2200 and 2201 for dynamic policy management with multi-path delivery in accordance with this disclosure. The processes 2200 and 2201 illustrated in FIGS. 22A and 22B are for illustration only. FIGS. 22A and 22B do not limit the scope of this disclosure to any particular implementation of a process for dynamic policy management with multi-path delivery. For ease of explanation, the processes 2200 and 2201 of FIGS. 22A and 22B may be described as being performed using the communication system 100 of FIG. 1. However, the processes 2200 and 2201 may be used with any other suitable system and using any other suitable electronic device(s).

As shown in FIGS. 22A and 22B, the processes 2200 and 2201 involve a UE 2202 and an operator core 2204. The operator core 2204 includes a network entity or apparatus, e.g., an AF 2206. As described in this disclosure a procedure can be used for enhancing policy management in media streaming where in the UE requests for a policy (or QoS treatment) and the AF works with network entities to realize the requested QoS for media application flows of the UE. As shown in FIGS. 22A and 22B, an AS 2208 can communicate with a UPF 2210. Various paths across different access networks can be set up between the UE 2202 and the UPF 2210 based on the dynamic policy management, such as based on current QoS measurements. For example, in the process 2200 of FIG. 22A, two paths are setup, one across a first access network 2212 and another across a second access network 2214. In the process 2201 of FIG. 22B, three paths are setup, one across the first access network 2212, another across the second access network 2214, and yet another across the third access network 2216.

To facilitate dynamic policy management in the processes 2200 and 2201, the below information in Table 10 may be included in the multi-path delivery notification information (such as described in FIGS. 20A and 20B) and sent to the UE so that the UE can pick the appropriate delivery option.

TABLE 10

| Information element | Description | |
|---|---|---|
| delivery_metrics_map | The AF sends delivery metrics mapping information to the UE. Each | |
| | element of the map is in the form of <key, value> pair where key and | |
| | pair are formulated as below: | |
| | ‘Key’ represents a connection metric. For example, the metric could be | |
| | any of metrics such as bit rate, packet latency, packet loss rate, | |
| | PDUSet QoS parameters. Each element of the map represents a | |
| | different metric. The possible list of metrics that may be included may | |
| | be negotiated between the UE and the AF, or configured by the | |
| | application service provider. | |
| | Value is an object of expected measurements of the above metric for | |
| | different combinations of paths/sub-flows if used for media delivery. | |
| | For example, in FIG. 22A when there are two paths between the UE | |
| | and network for media delivery, and the UE may be able to use those | |
| | two paths for the session, the value object may have the following | |
| | information: | |
| | Path | Expected metric measurement |
| | Path 1 alone | <metric-value-if-only-using-path-1> |
| | Path 2 alone | <metric-value-if-only-using-path-2> |
| | Path 1 and Path 2 | <metric-value-if-using-both-path- |
| | simultaneously | 1_and_path-2> |
| | In FIG. 22B when there are three paths between the UE and network | |
| | for media delivery, and the UE may be able to use those three paths for | |
| | the session, the value object may have the following information: | |
| | Path | Expected metric measurement |
| | Path 1 alone | <metric-value-if-only-using-path- |
| | | 1> |
| | Path 2 alone | <metric-value-if-only-using-path- |
| | | 2> |
| | Path 3 alone | <metric-value-if-only-using-path- |
| | | 3> |
| | Path 1 and Path 2 simultaneously | <metric-value-if-using-both-path- |
| | | 1_and_path-2> |
| | Path 2 and Path 3 simultaneously | <metric-value-if-using-both-path- |
| | | 2_and_path-3> |
| | Path 1 and Path 3 simultaneously | <metric-value-if-using-both-path- |
| | | 1_and_path-3> |
| | Path 1 and Path 2 and Path 3 | <metric-value-if-using-all-path- |
| | simultaneously | 1_and_path-2_and_path-3> |

The value object is constructed as above for each combination of paths
for as many paths between the UE and the network.

When the UE 2202 receives the above delivery metrics map information from the AF 2206 for all metrics, it may assess the benefit of switching to/from multi-path delivery, and the combinations of paths to use for best service performance by looking at the measurements for all connection metrics. The UE 2202 can then infer the appropriate combination of paths to use based on above delivery metrics map information, along with local configuration information, and user preferences. Based on the chosen path combination, the UE 2202 can set up or tear down multi-path delivery session, or modify existing session to get appropriate service experience with multi-access session.

Although FIGS. 22A and 22B illustrate example processes 2200 and 2201 for dynamic policy management with multi-path delivery, various changes may be made to FIGS. 22A and 22B. For example, the number and placement of various components of the processes 2200 and 2201 can vary as needed or desired. In addition, the processes 2200 and 2201 may be used in any other suitable process or other architectures, such as other architectures of this disclosure, and are not limited to the specific processes or architectures described above.

In various embodiments, application feedback can be provided for managing multi-access media delivery. For example, in some embodiments, a UE may send application feedback information to the network apparatus (e.g., an AF) to get recommendation for enabling or disabling multi-access media delivery over multiple network interfaces and/or access networks. In some embodiments, a UE may use the M5 application API specified in TS 26.510 to send this information to the AF. Alternatively, the network assistance features specified in TS 26.501 and TS 26.510 may be used to send application feedback information to the AF to request the AF about recommendation for optimizing application performance.

In various embodiments, to send the application feedback information, a UE may include the various details. Such details can include per-access, per-sub flow, or per-path QoS information: The UE may send the QoS information such as the available bit rate, bandwidth, current packet loss, packet delay, jitter, buffer levels etc. to the AF per different network interface or per-different sub-flow (if the UE is currently using MPTCP steering functionality for its multi-access implementation), or per-path (if the UE is currently using MPQUIC steering functionality for its multi-access implementation), or per IP flow (if the UE is currently using ATSSS-LL steering functionality for its multi-access implementation). Preferred steering functionality can also be used in which the UE preference of steering functionality (whether MPTCP, MPQUIC, ATSSS-LL, custom, etc.) is used.

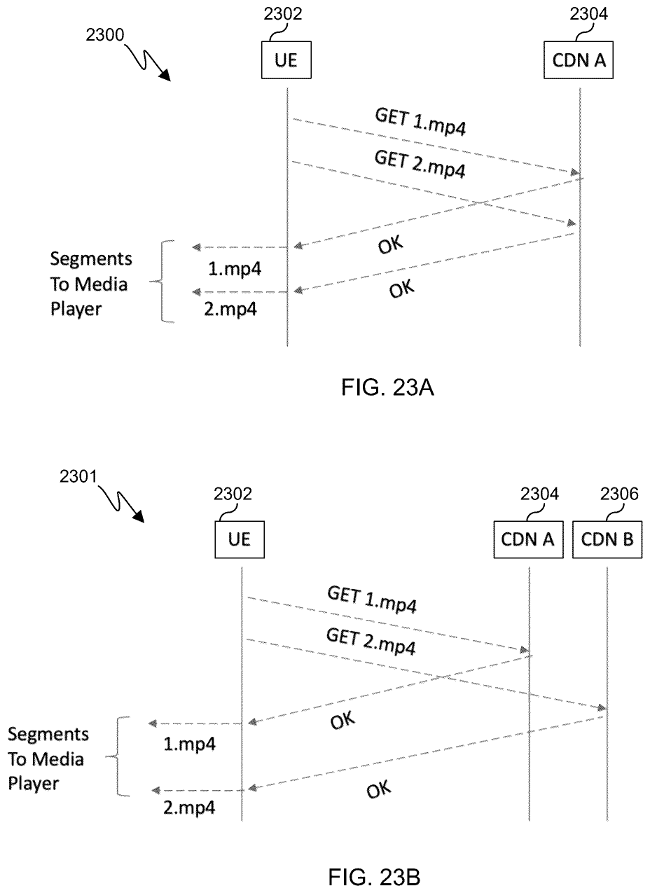

FIG. 23A illustrates an example single CDN delivery process 2300 in accordance with this disclosure and FIG. 23B illustrates an example multi-CDN delivery process 2301 in accordance with this disclosure. The processes 2300 and 2301 illustrated in FIGS. 23A and 23B are for illustration only. FIGS. 23A and 23B do not limit the scope of this disclosure to any particular implementation of a single CDN delivery process or a multi-CDN delivery process. For ease of explanation, the processes 2300 and 2301 of FIGS. 23A and 23B may be described as being performed using the communication system 100 of FIG. 1. However, the processes 2300 and 2301 may be used with any other suitable system and using any other suitable electronic device(s).

As shown in FIG. 23A, in the single CDN delivery process 2300, a UE 2302 is connected to a single CDN server 2304. The UE 2302 sends a request to access all media segments to the same CDN server 2304. When the CDN server 2304 receives a request from the UE 2302 for a media segment, provided sufficient authorization credentials, the CDN server 2304 responds back to the UE 2302 with success response and the requested media segment. As and when the UE 2302 receives the media segments from the CDN server 2304, the UE will send the media segments to a player (for example a media player) to play the received media segments.

As shown in FIG. 23B, in a multi-CDN delivery mechanism, the UE 2302 may request different media segments to different CDN servers 2304, 2306 in different content distribution networks, and the CDN servers 2304, 2306 in those CDNs respond back to the UE 2302 with an OK message and the corresponding media segments. From an implementation perspective, a single CDN delivery process 2300 and multi-CDN delivery process 2301 is not different as the UE 2302 just reaches multiple CDN servers in different CDN networks in the multi-CDN delivery process 2301 for different segments, while the UE reaches the same CDN server for all the segments.

The multi-CDN delivery process 2301 wherein the UE 2302 sends requests to different CDN servers 2304, 2306 in different content delivery networks for media segments, the same mechanism can also apply for individual objects. Additionally, the same mechanisms can apply for partial media segments, e.g., using byte range requests, where the UE 2302 requests partial media segments to the different CDN servers 2304, 2306 in the different CDNs, receives those partial media segments, and aggregates them in the UE buffer before forwarding them to the media player. Alternatively, the UE 2302 can just forward the partial media segments to the media player, and the media player takes the responsibility of re-constructing the media segments and playing them.

In another embodiment, the UE 2302 optionally receives information regarding the availability and/or load status of multiple CDN servers 2304, 2306. Based on the received information, the UE selects CDN servers for requesting media segments or partial media segments For instance, the UE 2302 may request media segments from CDN servers that are indicated as available during the time window that the UE is requesting media or partial media segments. If there are a plurality of CDN server that are available to serve during a time window, UE may request media segments or partial media segments based on latency, throughput, or overall reliability status of the multiple CDN servers. Alternatively, the UE 2302 may use predictive mechanisms based on historical data to anticipate CDN server performance and distribute requests among CDN servers to enhance streaming quality and reliability.

Although FIG. 23A illustrates an example single CDN delivery process 2300 and FIG. 23B illustrates an example multi-CDN delivery process 2301, various changes may be made to FIGS. 23A and 23B. For example, the number and placement of various components of the processes 2300 and 2301 can vary as needed or desired. In addition, the processes 2300 and 2301 may be used in any other suitable process or other architectures, such as other architectures of this disclosure, and are not limited to the specific processes or architectures described above.

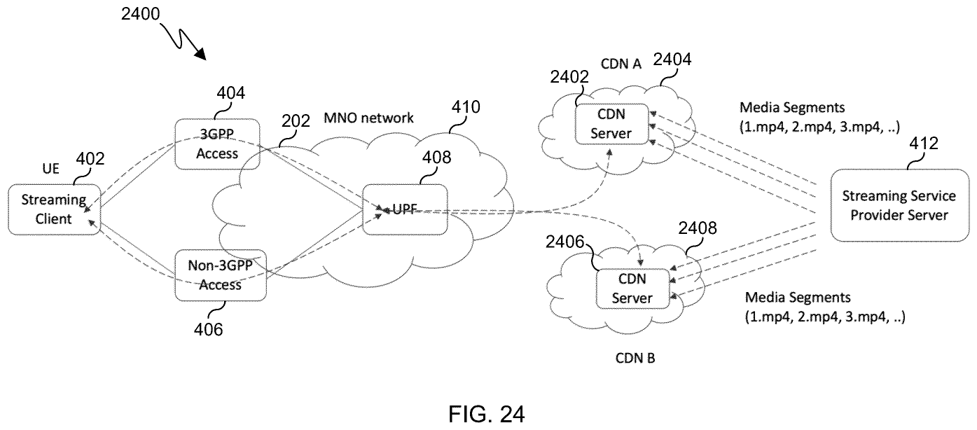

FIG. 24 illustrates an example process 2400 for multi-CDN and multi-access delivery through MNO supported access networks in accordance with this disclosure. The process 2400 illustrated in FIG. 24 is for illustration only. FIG. 24 does not limit the scope of this disclosure to any particular implementation of a process for multi-CDN and multi-access delivery through MNO supported access networks. For ease of explanation, the process 2400 of FIG. 24 may be described as being performed using the communication system 100 of FIG. 1. However, the process 2400 may be used with any other suitable system and using any other suitable electronic device(s).

As shown in FIG. 24, the process 2400 includes using the streaming client 402, the cellular access network 404, the non-cellular access network 406, the UPF 408, the MNO network 410, and the streaming service provider server 412, such as described with respect to FIG. 4.

As further shown in FIG. 24, the process 2400 includes a multi-CDN and multi-access delivery mechanism where the streaming service provider server 412 publishes media segments to one or more CDN servers in different CDN networks, e.g., a first CDN server 2402 in a first CDN network 2404, and a second CDN server 2406 in a second CDN network 2408. The streaming client 402 of the UE may request media segments from one or more of the CDN servers and receive content through one or more of the access networks 404, 406. For uplink streaming use cases, streaming clients such as the streaming client 402 may upload media content to one or more of the CDN servers in different CDN networks through one or more access networks that the UE may be able to use for uplink delivery. As further shown in FIG. 24, the access networks 404, 406 are MNO supported access networks.

In another embodiment, the UE optionally receives information regarding the availability and/or load status of the different access network and/or CDN servers. Based on the received information, the UE selects the access network/s and CDN server/s for requesting media segments.

Although FIG. 24 illustrates one example process 2400 for multi-CDN and multi-access delivery through MNO supported access networks, various changes may be made to FIG. 24. For example, the number and placement of various components of the process 2400 can vary as needed or desired. In addition, the process 2400 may be used in any other suitable process or other architectures, such as other architectures of this disclosure, and is not limited to the specific processes or architectures described above.

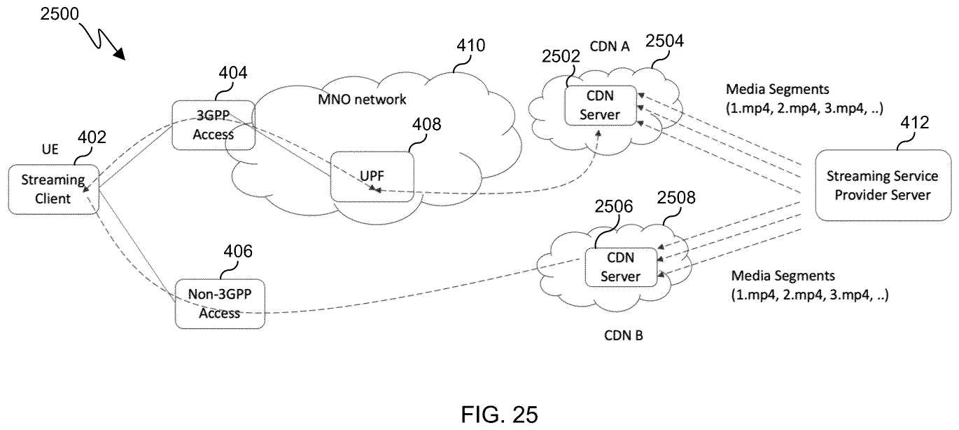

FIG. 25 illustrates an example process 2500 for multi-CDN and multi-access delivery through an MNO supported access network and an unmanaged access network in accordance with this disclosure. The process 2500 illustrated in FIG. 25 is for illustration only. FIG. 25 does not limit the scope of this disclosure to any particular implementation of a process 2500 for multi-CDN and multi-access delivery through an MNO supported access network and an unmanaged access network. For ease of explanation, the process 2500 of FIG. 25 may be described as being performed using the communication system 100 of FIG. 1. However, the process 2500 may be used with any other suitable system and using any other suitable electronic device(s).

As shown in FIG. 25, the process 2500 includes using the streaming client 402, the cellular access network 404, the non-cellular access network 406, the UPF 408, the MNO network 410, and the streaming service provider server 412, such as described with respect to FIG. 4.

As further shown in FIG. 25, the process 2500 also includes a multi-CDN and multi-access delivery mechanism where the streaming service provider server 412 publishes media segments to one or more CDN servers in different CDN networks, e.g., a first CDN server 2502 in a first CDN network 2504, and a second CDN server 2506 in a second CDN network 2508. The streaming client 402 of the UE may request media segments from one or more of the CDN servers and receive content through one or more of the access networks 404, 406. However, unlike FIG. 24 where the access networks were all MNO supported, in FIG. 25 the access networks are either supported by the MNO or unsupported/unmanaged by the MNO (e.g., Wi-Fi). In this example, the cellular access network 404 is MNO supported and the non-cellular access network 406 is unsupported/unmanaged. In such a scenario, the streaming client 402 of the UE connects to the each of the CDN servers 2502, 2506 either through the MNO supported access network 404 or directly through the MNO independent access network 406.

Although FIG. 25 illustrates one example process 2500 for multi-CDN and multi-access delivery through an MNO supported access network and an unmanaged access network, various changes may be made to FIG. 25. For example, the number and placement of various components of the process 2500 can vary as needed or desired. In addition, the process 2500 may be used in any other suitable process or other architectures, such as other architectures of this disclosure, and is not limited to the specific processes or architectures described above.

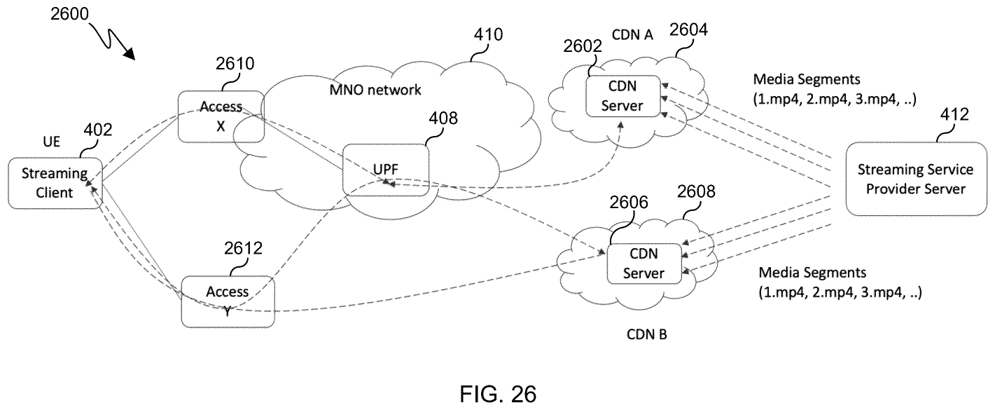

Even though FIG. 25 shows a UE connected to different CDN servers exclusively through specific access networks, in various embodiments the UE can alternatively connect to multiple CDN servers through the same access network. For example, FIG. 26 a process 2600 for multi-CDN and multi-access delivery through multiple access networks in accordance with this disclosure. The process 2600 illustrated in FIG. 26 is for illustration only. FIG. 26 does not limit the scope of this disclosure to any particular implementation of a process 2600 for multi-CDN and multi-access delivery through multiple access networks. For ease of explanation, the process 2600 of FIG. 26 may be described as being performed using the communication system 100 of FIG. 1. However, the process 2600 may be used with any other suitable system and using any other suitable electronic device(s).

FIG. 26 illustrates an example process 2600 for multi-CDN and multi-access delivery through an MNO supported access network and an unmanaged access network in accordance with this disclosure. The process 2600 illustrated in FIG. 26 is for illustration only. FIG. 26 does not limit the scope of this disclosure to any particular implementation of a process 2600 for multi-CDN and multi-access delivery through an MNO supported access network and an unmanaged access network. For ease of explanation, the process 2600 of FIG. 26 may be described as being performed using the communication system 100 of FIG. 1. However, the process 2600 may be used with any other suitable system and using any other suitable electronic device(s).

As shown in FIG. 26, the process 2600 includes using the streaming client 402, the UPF 408, the MNO network 410, and the streaming service provider server 412, such as described with respect to FIG. 4.

As further shown in FIG. 26, the process 2600 also includes a multi-CDN and multi-access delivery mechanism where the streaming service provider server 412 publishes media segments to one or more CDN servers in different CDN networks, e.g., a first CDN server 2602 in a first CDN network 2604, and a second CDN server 2606 in a second CDN network 2608. The streaming client 402 of the UE may request media segments from one or more of the CDN servers and receive content through one or more of the access networks, e.g., a first access network 2610 and a second access network 2612. As shown in FIG. 26, in this example, a stream from the first CDN server 2602 takes place over the first access network 2610 and a stream from the second CDN server 2606 takes place over the second access network 2612. In another embodiment, the UE optionally receives information regarding the availability and/or load status of the different access network and/or CDN servers. Based on the received information, the UE requests media segments from different access network/s and CDN server/s. As further shown in FIG. 26, even where the access network 2612 is an MNO unsupported access network, a network entity such as the UPF 408 can still operate to facilitate streaming connections between the streaming client 402 and the second CDN server 2606 via the second access network 2612.

Thus, with Multi-CDN and Multi-access delivery mechanisms, various functions are possible. For example, CDNs can be made available through specific access networks. In various embodiments, a client such as the streaming client 402 can download a manifest file that tells the client where to download the media from. For example, DASH streaming protocol specifies that a DASH client gets access to a DASH manifest file (the MPD) that indicates to the client where to get different media segments from. This can be done using BaseURLs which specify the base URLs from where the media segments are to be fetched from. This information in the MPD with BaseURLs can be enhanced to include various information. For example, the following information in Table 11 is provided for each BaseURL in the MPD manifest file.

TABLE 11

| Information Element | Description |
|---|---|
| List_access_networks | List of access networks through which the media segments can be |
| | accessed from the given Base URL. The streaming service |
| | provider may provide a list of access networks through which the |
| | client may connect to the CDN server at the given BaseURL. |
| Preferred_access_network | Preferred access network using which the client has to connect to |
| | the BaseURL to download media segments. |
| | This option is provided by the streaming service provider if |
| | multiple access networks are available through which a client can |
| | request access to media segments. With this option, the streaming |
| | service provider tells the client the preferred access network |
| | among the given access networks the UE uses for connecting to |
| | the CDN service at the given CDN network. |
| | When this option is indicated, and the time_windows parameter is |
| | populated to a value other than null, it indicates that this is the |
| | preferred access network during the time periods indicated in the |
| | time_windows parameter. Alternatively, if the time_windows |
| | parameter is set to null, then it means that this is the preferred |
| | access network until otherwise indicated by an updated media |
| | description document. |
| Exclusive_access_network | The access network that provides exclusive access to the |
| | BaseURL for the UE. |
| | If this value is given to the UE, the UE is to request access to |
| | media segments over this access networks. The CDN server at the |
| | BaseURL is only accessible through this access network. A |
| | streaming service provider may provision exclusive performance |
| | CDN servers in a CDN network, and allows the UE to connect to |
| | this CDN server over an exclusive access network. This way, the |
| | UE gets access to premium content by only connecting using the |
| | indicated access network. For example, streaming service |
| | provider may indicate that the clients use 5G NR access network |
| | to receive premium content from a CDN server in an MNO |
| | preferred CDN network. Another variant of the example is that |
| | streaming service provider may indicate that the clients use 5G |
| | NR access network to receive premium content from an Edge |
| | CDN server in an MNO provisioned Edge CDN network. |
| | When this option is indicated to the UE, the UE has to switch |
| | accessing the service over to this exclusive_access_network to |
| | connect to the CDN server available at the CDN network. The |
| | UE may, depending on user preferences, continue to stay in the |
| | same access network it is currently connected to and continue to |
| | receive non-premium content |
| | When this option is indicated, and the time_windows parameter is |
| | populated to a value other than null, it indicates that this is the |
| | exclusive access network during the time periods indicated in the |
| | time_windows parameter. Alternatively, if the time_windows |
| | parameter is set to null, then it means that this is the exclusive |
| | access network until otherwise indicated by an updated media |
| | description document. |
| Time_Windows | List of time windows with specific times when the UE client is |
| | able to access the CDN servers at this BaseURL |
| List_split_access_networks | List of access networks through which the media segments can be |
| | split and accessed along with the given Base URL on the current |
| | access. The streaming service provider may provide a list of |
| | access networks through which the client may provide requests to |
| | multiple CDN servers in a split mode. In this mode, the UE client |
| | may request some segments over the current access network, and |
| | segments over the list of access networks indicated in this list. |
| | Additionally, this list may indicate the list of access networks |
| | through which the content is split and sent to the UE client. Which |
| | direction the split happens in specified by the direction parameter. |
| | When this option is indicated in the media description document, |
| | the streaming media service provider may additionally include the |
| | following information: |
| | split mode: Indicates how different requests are split |
| | among the current access network and one or more access |
| | networks in this list. Some of the possible options include |
| | round-robin, percentage-allocation (e.g. % of media |
| | segment requests over each of the access networks), |
| | current QoS (e.g., higher QoS access network is chosen |
| | for next request from UE client) |
| | split_time_periods: Specific time periods during which the |
| | requests from the UE client may be sent over current |
| | access network and one or more of the access networks in |
| | this list |
| List_steer_access_networks | List of access networks through which the media segments can be |
| | steered and accessed. The streaming service provider may provide |
| | a list of access networks through which the content may be |
| | steered. In this mode, the UE client may receive some partial |
| | segments over the current access network, and other partial |
| | segments over the list of access networks indicated in this list. |
| | Which direction the split happens in specified by the direction |
| | parameter. |
| | When this option is indicated in the media description document, |
| | the streaming media service provider may additionally include the |
| | following information: |
| | steer_time_periods: Specific time periods during which |
| | the requests from the UE client may be sent over current |
| | access network and one or more of the access networks in |
| | this list |
| Direction | Which direction the steering, switching, and spitting decisions |
| | described in this disclosure are to be carried out. Possible values |
| | are follows: |
| | Downlink: All the decisions described in this disclosure |
| | are to happen for downlink traffic only (from network to UE) |
| | Uplink: All the decisions described in this disclosure are to |
| | happen for uplink traffic only (from UE to network) |
| | Both: All the decisions described in this disclosure are to |
| | happen for both uplink and downlink traffic |
| Preferred_Alter- | List of URLs of alternate CDN Base URLs. The streaming service |
| nate_CDN_Base_URL_List | provider may provide this list of alternate Base URLs when it |
| | prefers the UE use different BaseURLs to access media segments |
| | when access networks are changed due to processes discussed in |
| | this disclosure. Each element in this list has the following |
| | information: |
| | Base URL: The BaseURL to use for requesting media |
| | segments |
| | Priority: Priority of BaseURL so the UE knows which |
| | CDN server, among a list of CDN servers, it needs to send |
| | a request to |
| | When this information is included in the media presentation |
| | description document, for each of the switching, splitting, and |
| | steering decisions taken that result in a different access network, |
| | the UE checks to see if the current BaseURL is reachable. If not, |
| | the UE client tries each of the BaseURL in this list, in the list of |
| | priority order i.e. BaseURL with highest priority are tried first |
| | before trying the next highest priority BaseURL. |
| | The above procedure is performed when any of the steering, |
| | switching, and splitting procedures described in this disclosure are |
| | undertaken for either of the full segments or partial media |
| | segments. |
| Setup_new_session | If this option is set to True, the UE client is to setup a new session |
| | over the new access if the access network is changed due to any of |
| | the splitting/switching/steering decisions described in this |
| | disclosure for either of the full segment retrieval or the partial |
| | media segment retrieval. |
| | If this option is set to False, the UE client is to use existing |
| | session over the new access if the access network is changed due |
| | to any of the splitting/switching/steering decisions described in |
| | this disclosure for either of the full segment retrieval or the partial |
| | media segment retrieval. |
| Change_session_type | If this option is set to True, the UE client is to setup a new type of |
| | session depending on the type of session management mode is |
| | provisioned access if the access network is changed due to any of |
| | the splitting/switching/steering decisions described in this |
| | disclosure for either of the full segment retrieval or the partial |
| | media segment retrieval. Possible session management modes are |
| | as follows: |
| | Single Access session: A separate session is to be setup |
| | over the new access |
| | Multi-access session: A multi-access session is to be setup |
| | spanning the current access and the new access |

In various embodiments of this disclosure, the streaming client can also fetch partial media segments through specific access networks. As described in this disclosure, media segments can be retrieved from specific CDN servers in specific CDN networks through specific access networks. Alternatively, however, the same procedure may be used to retrieve or fetch partial objects or partial segments from specific CDN servers in specific CDN networks through specific access networks. In this case, the UE streaming client 402 connects to the preferred access network or exclusive access network to retrieve partial media segments. The other partial media segments, or full media segments, may be retrieved using the normal access network that the UE client uses for media delivery. To facilitate the retrieval of partial media segments through specific CDN servers over specific access networks, the streaming service provider server 412 may provide the following information in Table 12 in the media description document, in addition to the other details described in this disclosure. The following information in Table 12 is included for each BaseURL that is described in the media description Document.

TABLE 12

| Information Elements | Description |
|---|---|
| List timed_partial_segments | List of partial timed retrieval descriptors. Each object in the |
| | list consists of the following information: |
| | Time range: Time range during which the below |
| | partial media segments have to be retrieved |
| | Partial media segments: Byte range of media |
| | segments that have to be retrieved during the above |
| | time range |
| | Exclusive: Boolean variable describing whether the |
| | UE client uses the CDN server at this BaseURL to |
| | retrieve the partial media segments or objects over |
| | current access network |
| | Switch_to_exclusive_access: Boolean variable |
| | indicating that the UE client switch to exclusive |
| | access network to retrieve the given partial media |
| | segment objects. If this variable is set to true, then |
| | the UE may only be able to retrieve the given |
| | partial objects from specific CDN server over the |
| | exclusive access network. |
| | For example, one of the objects in the above list may show |
| | the following information: |
| | Time range: 0 s-120 s |
| | Byte Range: 0-1M |
| | Exclusive: False |
| | Switch_to_exclusive_access: True |
| | When the above information is provided to the UE client, it |
| | switches to the exclusive access network to retrieve the |
| | given byte range of partial media segments for the given |
| | time range |
| | Once the time period given in Time range is expired, the |
| | UE may switch back to the regular access for accessing |
| | content from CDN servers at this BaseURL. |
| Fallback_access_network | This specifies the fallback access network that the UE client |
| | falls back to retrieve the partial media segments in case the |
| | UE client is unable to connect to the CDN server at |
| | specified BaseURL over the exclusive access network |
| List_split_access_networks | List of access networks through which the partial media |
| | segments can be split and accessed along with the given |
| | Base URL on the current access. The streaming service |
| | provider may provide a list of access networks through |
| | which the client may provide requests to multiple CDN |
| | servers in a split mode. In this mode, the UE client may |
| | request some partial segments over the current access |
| | network, and other partial segments over the list of access |
| | networks indicated in this list. Additionally, this list may |
| | indicate the list of access networks through which the |
| | content is split and sent to the UE client. Which direction |
| | the split happens in specified by the direction parameter. |
| | When this option is indicated in the media description |
| | document, the streaming media service provider may |
| | additionally include the following information: |
| | split mode: Indicates how different requests are split |
| | among the current access network and one or more |
| | access networks in this list. Some of the possible |
| | options include round-robin, percentage-allocation |
| | (e.g. % of media segment requests over each of the |
| | access networks), current QoS (e.g., higher QoS |
| | access network is chosen for next request from UE |
| | client) |
| | split_time_periods: Specific time periods during |
| | which the requests from the UE client may be sent |
| | over current access network and one or more of the |
| | access networks in this list |
| List_steer_access_networks | List of access networks through which the partial media |
| | segments can be steered and accessed. The streaming |
| | service provider may provide a list of access networks |
| | through which the content may be steered. In this mode, the |
| | UE client may receive some partial segments over the |
| | current access network, and other partial segments over the |
| | list of access networks indicated in this list. |
| | Which direction the steering happens in specified by the |
| | direction parameter. |
| | When this option is indicated in the media description |
| | document, the streaming media service provider may |
| | additionally include the following information: |
| | steer_time_periods: Specific time periods during |
| | which the requests from the UE client may be sent |
| | over current access network and one or more of the |
| | access networks in this list. |

In various embodiments, the streaming service provider server 412 may control the type of content each of the UE clients retrieve from specific CDN servers over specific access networks, for example to provide premium services. In some embodiments, the streaming service provider may enable the UE client to retrieve the main service content through the traditional access network, but provide information in media description document to enable downloading overlay content from a different CDN server over a different access network.

In some embodiments, the above procedure and information elements may be used for retrieving full media segments instead of partial media segments through specific CDN servers over specific access networks.

Although FIG. 26 illustrates one example process 2600 for multi-CDN and multi-access delivery through multiple access networks, various changes may be made to FIG. 26. For example, the number and placement of various components of the process 2600 can vary as needed or desired. In addition, the process 2600 may be used in any other suitable process or other architectures, such as other architectures of this disclosure, and is not limited to the specific processes or architectures described above.

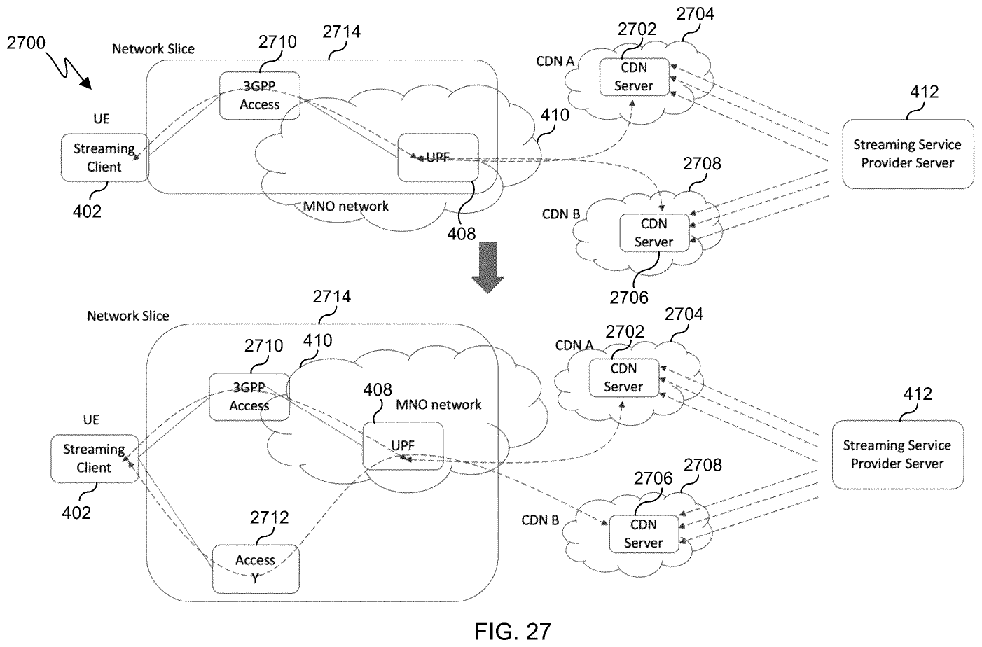

FIG. 27 illustrates an example process 2700 for multi-CDN and multi-access delivery with network slicing in accordance with this disclosure. The process 2700 illustrated in FIG. 27 is for illustration only. FIG. 27 does not limit the scope of this disclosure to any particular implementation of a process 2700 for multi-CDN and multi-access delivery with network slicing. For ease of explanation, the process 2700 of FIG. 27 may be described as being performed using the communication system 100 of FIG. 1. However, the process 2700 may be used with any other suitable system and using any other suitable electronic device(s).

As shown in FIG. 27, the process 2700 includes using the streaming client 402, the UPF 408, the MNO network 410, and the streaming service provider server 412, such as described with respect to FIG. 4.

As further shown in FIG. 27, the process 2700 also includes a multi-CDN and multi-access delivery mechanism where the streaming service provider server 412 publishes media segments to one or more CDN servers in different CDN networks, e.g., a first CDN server 2702 in a first CDN network 2704, and a second CDN server 2706 in a second CDN network 2708. The streaming client 402 of the UE may request media segments from one or more of the CDN servers and receive content through one or more of the access networks, e.g., a first access network 2710 and a second access network 2712.

As described in this disclosure, full or partial media objects can be fetched from specific CDN servers over specific access networks. As shown in FIG. 27, in various embodiments, with multiple access, a separate network slice 2714 may be setup that spans multiple access networks as a result of setting up sessions due to various processes described in this disclosure. In another embodiment, the UE optionally receives information regarding the availability and/or load status of the different access network, different slices and/or CDN servers. Based on the received information, the UE may request media segments from different access network/s, slice/s and CDN server/s. The following network slice management options in Table 13 are therefore possible for multi-access multi-CDN delivery.

TABLE 13

| Procedure | Description |
|---|---|
| Setup new network slice | When a change in access network is observed due to any of the |
| | procedures described in this disclosure happen, a new network slice |
| | may be setup based on provisioning information from the streaming |
| | service provider. To facilitate this procedure: |
| | The streaming service provider performs offline negotiation |
| | with the operator to request potential slice deployment. |
| | However, the network slice may not be provisioned and |
| | activated until some conditions are satisfied. |
| | Provisioning_conditions: Conditions to satisfy to provision |
| | network slice. Possible conditions include: |
| | Drop in QoS: When the QoS on new access networks |
| | perform worse than QoS on current access networks, |
| | the conditions satisfy. Different quality parameters |
| | such as delay, latency, throughput bandwidth etc. |
| | may be checked to see if the QoS is bad. The |
| | streaming service provider may provision acceptable |
| | tolerance limits, or drop off limits, for each of the |
| | quality parameters. Any drop off beyond the |
| | acceptable limits indicate drop off in QoS |
| | Time_periods: Specific time periods when |
| | provisioning of network slice is considered. The |
| | streaming service provider may provision specific |
| | time periods during which the provisioning of |
| | network slice may be considered. |
| | Activation_conditions: Conditions to satisfy to activate |
| | network slice. Possible conditions include: |
| | Drop in QoS: When the QoS on new access networks |
| | perform worse than QoS on current access networks, |
| | the conditions satisfy. Different quality parameters |
| | such as delay, latency, throughput bandwidth etc. |
| | may be checked to see if the QoS is bad. The |
| | streaming service provider may provision acceptable |
| | tolerance limits, or drop off limits, for each of the |
| | quality parameters. Any drop off beyond the |
| | acceptable limits indicate drop off in QoS |
| | Time_periods: Specific time periods when activation |
| | of network slice is considered. The streaming service |
| | provider may provision specific time periods during |
| | which the provisioning of network slice may be |
| | considered. |
| | Slice QoS: The QoS parameters for the slice are setup with |
| | the lower of QoS values currently applicable to any of the |
| | access networks over which the network slice is to span. |
| | Possible conditions include: |
| | Drop in QoS: When the QoS on new access networks |
| | perform worse than QoS on current access networks, |
| | the conditions satisfy. Different quality parameters |
| | such as delay, latency, throughput bandwidth etc. |
| | may be checked to see if the QoS is bad. The |
| | streaming service provider may provision acceptable |
| | tolerance limits, or drop off limits, for each of the |
| | quality parameters. Any drop off beyond the |
| | acceptable limits indicate drop off in QoS |
| | Time_periods: Specific time periods when |
| | provisioning of network slice is considered. The |
| | streaming service provider may provision specific |
| | time periods during which the provisioning of |
| | network slice may be considered. |
| Modify network slice | The current network slice that spans the access network may be |
| | modified if the access network is changed because of the procedures |
| | described in this disclosure. Following are the details for this |
| | procedure: |
| | The slice spanning the current access network maybe |
| | enhanced to span the new access network to which the |
| | split/steer/split procedures described in this disclosure have |
| | been made. |
| | When the above option is set, the network operator sets up a |
| | new multi-access PDU session spanning the current access |
| | network and the new access network, and performs slice |
| | management procedure to bring the new access under the |
| | same network slice. |
| | Optionally, a new slice spanning new access network, to |
| | which the split/steer/split procedures have been made, may |
| | be setup as described earlier in the disclosure. |
| | Modification_conditions: Conditions when the network slice |
| | modification is sought. Possible conditions include: |
| | Drop in QoS: When the QoS on new access networks |
| | perform worse than QoS on current access networks, |
| | the conditions satisfy. Different quality parameters |
| | such as delay, latency, throughput bandwidth etc. |
| | may be checked to see if the QoS is bad. The |
| | streaming service provider may provision acceptable |
| | tolerance limits, or drop off limits, for each of the |
| | quality parameters. Any drop off beyond the |
| | acceptable limits indicate drop off in QoS |
| | Time_periods: Specific time periods when |
| | provisioning of network slice is considered. The |
| | streaming service provider may provision specific |
| | time periods during which the provisioning of |
| | network slice may be considered. |

Various embodiments of this disclosure also allow for streaming of different representations over different access networks. As described in this disclosure, steering/switching/splitting over multiple access networks and requesting full and partial media segments from specific CDN servers in specific CDNs over specific access networks can be performed. In some embodiments, a procedure wherein different representations are managed with aspects discussed in this disclosure can be achieved. For example, methods for adaptive media delivery are possible and can be enabled using streaming protocol media description documents, such as DASH MPDs, where one or more representations are indicated for client to request based on current network QoS. Thus, the manifest can be enhanced to include one or more access networks, and the EU client can use the media description document or manifest to download/upload appropriate media representations. It will be understood that the various methods and procedures specified in this disclosure can be applied for different representations described in the manifest document. In addition to the above, the manifest or media presentation documents may be enhanced to include timing information (e.g., different time periods) during which different procedures described in this disclosure apply.

Although FIG. 27 illustrates one example process 2700 for 2700 for multi-CDN and multi-access delivery with network slicing, various changes may be made to FIG. 27. For example, the number and placement of various components of the process 2700 can vary as needed or desired. In addition, the process 2700 may be used in any other suitable process or other architectures, such as other architectures of this disclosure, and is not limited to the specific processes or architectures described above.

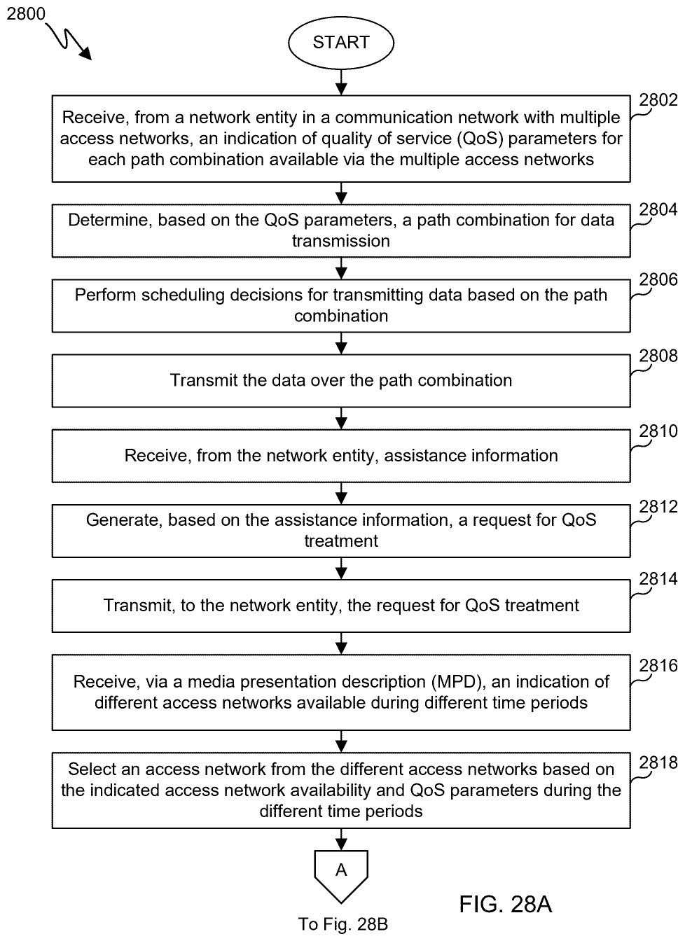

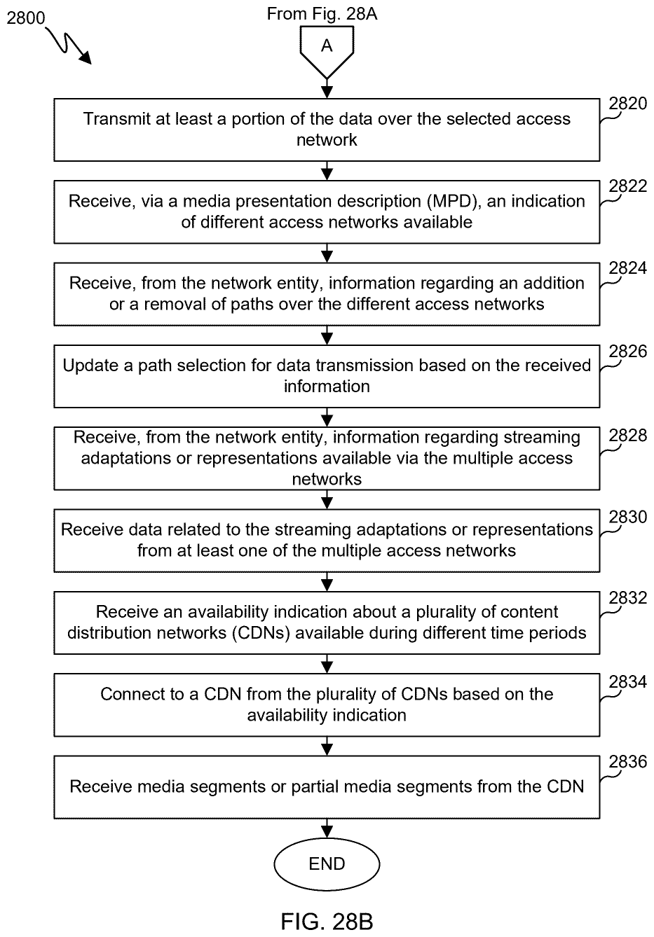

FIGS. 28A and 28B illustrate an example method 2800 for multi-access delivery for a user equipment apparatus in accordance with this disclosure. For ease of explanation, the method 2800 of FIGS. 28A and 28B is described as being performed using the electronic device 300 of FIG. 3. However, the method 2800 may be used with any other suitable system and any other suitable electronic device.

As shown in FIGS. 28A and 28B, at step 2802 the user equipment apparatus receives, from a network entity in a communication network with multiple access networks, an indication of quality of service (QOS) parameters for each path combination available via the multiple access networks. At step 2804, the user apparatus determines, based on the QoS parameters, a path combination for data transmission. At step 2806, the user apparatus performs scheduling decisions for transmitting data based on the path combination. At step 2808, the user apparatus transmits the data over the path combination.

As further illustrated in FIGS. 28A and 28B, the user apparatus can, at step 2810, receive, from the network entity, assistance information. At step 2812, the user apparatus generates, based on the assistance information, a request for QoS treatment. In various embodiments of this disclosure, the request for QoS treatment can include an access network from the multiple access networks, a path, a connection, and a sub-flow over which the QoS treatment is to be applied. At step 2814, the user apparatus transmits, to the network entity, the request for QoS treatment.

As further illustrated in FIGS. 28A and 28B, at step 2816, the user apparatus can receive, via a media presentation description (MPD), an indication of different access networks available during different time periods. In various embodiments of this disclosure, the indication of the different access networks can include, for the different access networks, minimum, maximum, and average: (i) bit rates, (ii) bandwidth, (iii) latency, and (iv) throughput available during the different time periods. At step 2818, the user apparatus selects an access network from the different access networks based on the indicated access network availability and QoS parameters during the different time periods. At step 2820, the user apparatus transmits at least a portion of the data over the selected access network.

As further illustrated in FIGS. 28A and 28B, at step 2822, the user apparatus can receive, via a media presentation description (MPD), an indication of different access networks available. At step 2824, the user apparatus receives, from the network entity, information regarding an addition or a removal of paths over the different access networks. At step 2826, the user apparatus updates a path selection for data transmission based on the received information.

As further illustrated in FIGS. 28A and 28B, at step 2828, the user apparatus can receive, from the network entity, information regarding streaming adaptations or representations available via the multiple access networks. At step 2830, the user apparatus receives data related to the streaming adaptations or representations from at least one of the multiple access networks.

As further illustrated in FIGS. 28A and 28B, at step 2832, the user apparatus can receive an availability indication about a plurality of content distribution networks (CDNs) available during different time periods. At step 2834, the user apparatus connects to a CDN from the plurality of CDNs based on the availability indication. At step 2836, the user apparatus receives media segments or partial media segments from the CDN.

Although FIGS. 28A and 28B illustrate one example of a method 2800 for multi-access delivery for a user equipment apparatus, various changes may be made to FIGS. 28A and 28B. For example, while shown as a series of steps, various steps in FIGS. 28A and 28B may overlap, occur in parallel, or occur any number of times (including zero times). It will be understood that the processes described in the various embodiments of this disclosure could be performed by the user equipment apparatus, and, as such, steps illustrated in FIGS. 28A and 28B could be added or removed according to this disclosure. For example, the user equipment apparatus may only perform a subset of the steps illustrated in FIGS. 28A and 28B when performing the method 2800.

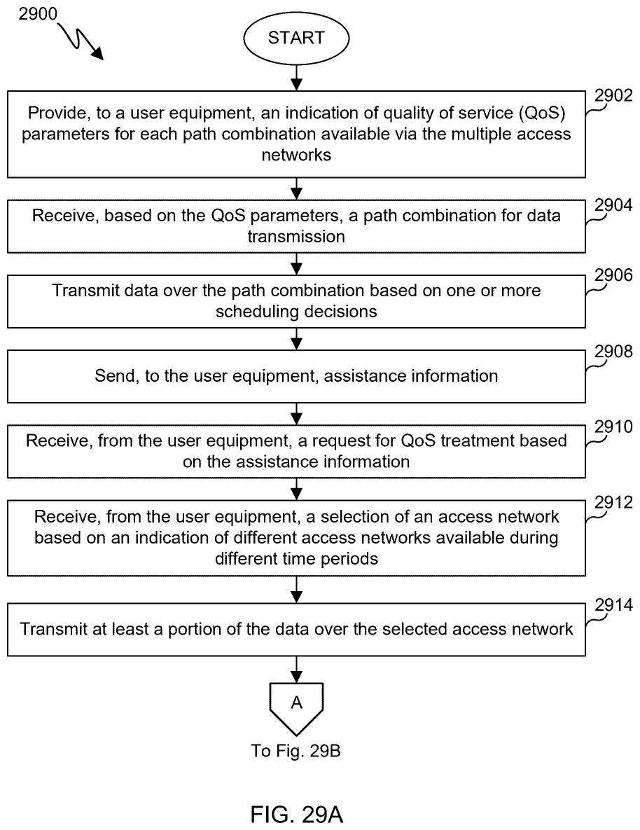

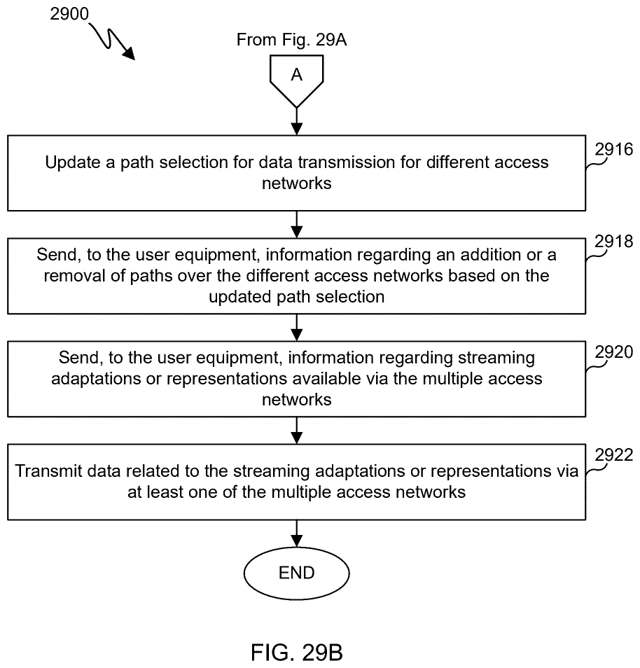

FIGS. 29A and 29B illustrate an example method 2900 using multi-access delivery for a network entity apparatus in accordance with this disclosure. For ease of explanation, the method 2900 of FIGS. 29A and 29B is described as being performed using the electronic device 300 of FIG. 3. However, the method 2900 may be used with any other suitable system and any other suitable electronic device.

As shown in FIGS. 29A and 29B, at step 2902 the network entity apparatus provides, to a user equipment, an indication of quality of service (QOS) parameters for each path combination available via the multiple access networks. At step 2904, the network entity apparatus receives, based on the QoS parameters, a path combination for data transmission. At step 2906, the network entity apparatus transmits data over the path combination based on one or more scheduling decisions.

As further shown in FIGS. 29A and 29B, at step 2908, the network entity apparatus can send, to the user equipment, assistance information. At step 2910, the network entity apparatus receives, from the user equipment, a request for QoS treatment based on the assistance information. In various embodiments of this disclosure, the request for QoS treatment can include an access network from the multiple access networks, a path, a connection, and a sub-flow over which the QoS treatment is to be applied.

As further shown in FIGS. 29A and 29B, at step 2912, the network entity apparatus can receive, from the user equipment, a selection of an access network based on an indication of different access networks available during different time periods. In various embodiments of this disclosure, the selection can be further based on the indicated access network availability and QoS parameters during the different time periods. In various embodiments of this disclosure, the indication of the different access networks can include, for the different access networks, minimum, maximum, and average: (i) bit rates, (ii) bandwidth, (iii) latency, and (iv) throughput available during the different time periods. At step 2914, the network entity apparatus transmits at least a portion of the data over the selected access network.

As further shown in FIGS. 29A and 29B, at step 2916, the network entity apparatus can update a path selection for data transmission for different access networks. At step 2918, the network entity apparatus sends, to the user equipment, information regarding an addition or a removal of paths over the different access networks based on the updated path selection.

As further shown in FIGS. 29A and 29B, at step 2920, the network entity apparatus can send, to the user equipment, information regarding streaming adaptations or representations available via the multiple access networks. At step 2922, the network entity apparatus transmits data related to the streaming adaptations or representations via at least one of the multiple access networks.

Although FIGS. 29A and 29B illustrate one example of a method 2900 for multi-access delivery using a network entity apparatus, various changes may be made to FIGS. 29A and 29B. For example, while shown as a series of steps, various steps in FIGS. 29A and 29B may overlap, occur in parallel, or occur any number of times (including zero times). It will be understood that the processes described in the various embodiments of this disclosure could be performed by the network entity apparatus, and, as such, steps illustrated in FIGS. 29A and 29B could be added or removed according to this disclosure. For example, the network entity apparatus may only perform a subset of the steps illustrated in FIGS. 29A and 29B when performing the method 2900.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE) in a communication network with multiple access networks, the method comprising:
receiving, from a network entity, an indication of quality of service (QOS) parameters for each path combination available via the multiple access networks;
determining, based on the QoS parameters, a path combination for data transmission;
performing scheduling decisions for transmitting data based on the path combination; and
transmitting the data over the path combination.

2. The method of claim 1, further comprising:
receiving, from the network entity, assistance information;
generating, based on the assistance information, a request for QoS treatment, wherein the request for QoS treatment includes:
an access network from the multiple access networks,
a path,
a connection, or
a sub-flow over which the QoS treatment is to be applied; and
transmitting, to the network entity, the request for QoS treatment.

3. The method of claim 1, further comprising:
receiving, via a media presentation description (MPD), an indication of different access networks available during different time periods;
selecting an access network from the different access networks based on the indicated access network availability and QoS parameters during the different time periods; and
transmitting at least a portion of the data over the selected access network.

4. The method of claim 3, wherein the indication of the different access networks includes, for the different access networks, minimum, maximum, and average: (i) bit rates, (ii) bandwidth, (iii) latency, and (iv) throughput available during the different time periods.

5. The method of claim 1, further comprising:
receiving, via a media presentation description (MPD), an indication of different access networks available;
receiving, from the network entity, information regarding an addition or a removal of paths over the different access networks; and
updating a path selection for data transmission based on the received information.

6. The method of claim 1, further comprising:
receiving, from the network entity, information regarding streaming adaptations or representations available via the multiple access networks; and
receiving data related to the streaming adaptations or representations from at least one of the multiple access networks.

7. The method of claim 1, further comprising:
receiving an availability indication about a plurality of content distribution networks (CDNs) available during different time periods;
connecting to a CDN from the plurality of CDNs based on the availability indication; and
receiving media segments or partial media segments from the CDN.

8. An apparatus comprising:
a transceiver; and
a processor operably coupled with the transceiver, the processor configured to:
receive, from a network entity in a communication network with multiple access networks, an indication of quality of service (QOS) parameters for each path combination available via the multiple access networks;
determine, based on the QoS parameters, a path combination for data transmission;
perform scheduling decisions for transmitting data based on the path combination; and
transmit the data over the path combination.

9. The apparatus of claim 8, wherein the processor is further configured to:
receive, from the network entity, assistance information;
generate, based on the assistance information, a request for QoS treatment, wherein the request for QoS treatment includes:
an access network from the multiple access networks,
a path,
a connection, or
a sub-flow over which the QoS treatment is to be applied; and
transmit, to the network entity, the request for QoS treatment.

10. The apparatus of claim 8, wherein the processor is further configured to:
receive, via a media presentation description (MPD), an indication of different access networks available during different time periods;
select an access network from the different access networks based on the indicated access network availability and QoS parameters during the different time periods; and
transmit at least a portion of the data over the selected access network.

11. The apparatus of claim 10, wherein the indication of the different access networks includes, for the different access networks, minimum, maximum, and average: (i) bit rates, (ii) bandwidth, (iii) latency, and (iv) throughput available during the different time periods.

12. The apparatus of claim 8, wherein the processor is further configured to:
receive, via a media presentation description (MPD), an indication of different access networks available;
receive, from the network entity, information regarding an addition or a removal of paths over the different access networks; and
update a path selection for data transmission based on the received information.

13. The apparatus of claim 8, wherein the processor is further configured to:
receive, from the network entity, information regarding streaming adaptations or representations available via the multiple access networks; and
receive data related to the streaming adaptations or representations from at least one of the multiple access networks.

14. The apparatus of claim 8, wherein the processor is further configured to:
receive an availability indication about a plurality of content distribution networks (CDNs) available during different time periods;
connect to a CDN from the plurality of CDNs based on the availability indication; and
receive media segments or partial media segments from the CDN.

15. A network entity apparatus in a communication network with multiple access networks, the network entity apparatus comprising:
a transceiver; and
a processor operably coupled with the transceiver, the processor configured to:
provide, to a user equipment (UE), an indication of quality of service (QOS) parameters for each path combination available via the multiple access networks;
receive, based on the QoS parameters, a path combination for data transmission; and
transmit data over the path combination based on one or more scheduling decisions.

16. The network entity apparatus of claim 15, wherein the processor is further configured to:
send, to the UE, assistance information; and
receive, from the UE, a request for QoS treatment based on the assistance information, wherein the request for QoS treatment includes:
an access network from the multiple access networks,
a path,
a connection, or
a sub-flow over which the QoS treatment is to be applied.

17. The network entity apparatus of claim 15, wherein the processor is further configured to:
receive, from the UE, a selection of an access network based on an indication of different access networks available during different time periods, wherein the selection is further based on the indicated access network availability and QoS parameters during the different time periods; and
transmit at least a portion of the data over the selected access network.

18. The network entity apparatus of claim 17, wherein the indication of the different access networks includes, for the different access networks, minimum, maximum, and average: (i) bit rates, (ii) bandwidth, (iii) latency, and (iv) throughput available during the different time periods.

19. The network entity apparatus of claim 15, wherein the processor is further configured to:
update a path selection for data transmission for different access networks; and
send, to the UE, information regarding an addition or a removal of paths over the different access networks based on the updated path selection.

20. The network entity apparatus of claim 15, wherein the processor is further configured to:
send, to the UE, information regarding streaming adaptations or representations available via the multiple access networks; and
transmit data related to the streaming adaptations or representations via at least one of the multiple access networks.
